(19) United States
(12) Patent Application Publication
(10) Pub. No.: US 2010/0018264 A1
(43) Pub. Date: Jan. 28, 2010

(54) LOCK ASSEMBLY, SYSTEMS AND METHODS FOR SECURING ENCLOSED SPACES

(75) Inventors: William D. Nygren, Denver, CO (US); Donald L. Lucas, Louisville, CO (US); Scott Edwards, Niwot, CO (US)

Correspondence Address: HOLLAND & HART, LLP, P.O BOX 8749, DENVER, CO, 80201, US

(73) Assignee: LOCKIN SECURITY, LLC, Niwot, CO (US)

(21) Appl. No.: 12/436,048

(22) Filed: May 5, 2009

Related U.S. Application Data
(60) Provisional application No. 61/126,388, filed on May 5, 2008.

(51) Int. Cl. E05B 65/00; E05C 19/00; E05C 5/04

(52) U.S. Cl. 70/91; 292/2; 292/251

(57) ABSTRACT

A lock assembly portion may include a housing assembly, first and second latches, at least one latch drive, and at least one actuator. The housing assembly includes a first end portion and an opposite second end portion. The first latch is associated with the first end portion. The second latch is associated with the second end portion. The at least one actuator interfaces the latch drive to the first and second latches. Operation of the latch drive causes the first and second latches to move relative to one another between respective extended and retracted positions.

### RELATED APPLICATIONS

This application is related and claims priority to U.S. Application No. 61/126,388, filed May 5, 2008 and titled LEAD SCREW LOCKING MECHANISM, the entire disclosure of which is hereby incorporated by reference.

### TECHNICAL FIELD

The present disclosure generally relates to locking mechanisms for use with doors.

### BACKGROUND

Enclosures are used for storing all types of items. Generally, an enclosure is an area that is at least partially enclosed by some type of wall or barrier. Enclosures typically have doors or gates allowing entry and exit, and insertion and removal of items. Enclosures may be relatively stationary or they may be portable and mobile. Sheds, houses and cabins are only a few examples of relatively stationary enclosures. Vehicles, trailers and storage containers can contain enclosures or themselves act as enclosures. Conventional approaches to securing many types of enclosures have been shown to be inadequate.

For example, in the construction industry, trailers are often used to store machines and other equipment during construction projects. Construction projects can last for long periods of time (e.g., months or years). The trailers often must remain on the construction site for long periods and are often left unguarded. As a result, trailers on construction sites are frequently broken into while the workers are away from the construction site. Traditionally, the trailers include a basic mechanism for closing the gates or doors of the trailer. For example, some trailers provide a vertical bar that can be raised to open the gates or lowered into a slot in the floor board to keep the gates closed. A cross-bar can be lowered across the gates and are typically locked with a padlock or similar locking device that is external to the trailer.

Padlocks are often insufficient to stop a thief from breaking into the trailer. Padlocks are easily cut with a tool, such as a cordless grinder or metal cutters. Once the padlock is broken, there is typically no other security mechanism preventing entry into the trailer. Thus, a thief armed with a basic tool can quickly and easily gain access to the contents of the trailer. After a thief gains entry, often times the thief positions a pickup or van next to the trailer opening and unloads the contents from the trailer into the van or pickup.

### SUMMARY

One aspect of the present disclosure relates to a lock assembly portion that includes a housing assembly, first and second latches, at least one latch drive, and at least one actuator. The housing assembly has a first end portion and an opposite second end portion. The first latch is associated with the first end portion. The second latch is associated with the second end portion. The at least one actuator interfaces the latch drive to the first and second latches, wherein operation of the latch drive causes the first and second latches to move relative to one another between respective extended and retracted positions.

Another aspect of the present disclosure relates to a lock assembly that includes a housing assembly, first and second latches, first and second receivers, a latch drive, a lead screw, and a lead screw guide. The housing assembly has a first end portion and an opposite second end portion. The first latch is associated with the first end portion and the second latch is associated with the second end portion. The first receiver is sized to accommodate the first latch, and the second receiver is sized to accommodate the second latch. The lead screw is operatively coupled between the latch drive and the latches. The lead screw guide is coupled for relative movement with the lead screw. Operation of the latch drive advances the latches relative to one another between respective retracted positions, wherein the latches are disengaged from their associated receivers, to respective extended positions wherein the latches engage their associated receivers.

A further aspect of the present disclosure is directed to a storage container. The storage container includes an enclosure having an interior, at least one door providing access to the interior, the door having an inside surface facing into the interior, and an opposite outer surface, and a lock assembly for securing the door to the enclosure. The lock assembly includes first and second housing members, first and second latch members, at least one latch actuator, and first and second latch receivers. The first housing member is mounted inwardly from the outer surface. The second housing member is mounted inwardly from the outer surface. The first latch member is associated with the first housing member, and the second latch member is associated with the second housing member. The at least one latch actuator is operably coupled to the first and second latch members. The first latch receiver is associated with the first latch member, and the second latch receiver is associated with the second latch member. The first and second latch receivers are mounted to the enclosure. Activation of the at least one latch actuator moves the first and second latches relative to one another between respective retracted positions, wherein the latches are disengaged from their associated receivers, to respective extended positions wherein the latches engage their associated receivers.

Another aspect of the present disclosure relates to a door assembly that includes a door and a portion of a lock assembly. The door includes an inner surface, an outer surface, and at least one cavity located between the inner and outer surfaces. The portion of a lock assembly is disposed in the cavity and includes a first and second housing members, first and second latch members, and a latch actuator. The first housing member has first and second ends. The second housing member has first and second ends. The first latch member may be associated with the first end of the first housing member. The second latch member may be associated with the first end of the second housing member. The latch actuator is operably coupled between the first and second housing members. Activation of the latch actuator moves the first and second housing members relative to each other to advance the first and second latch members out of the cavity in a plane parallel with the inner surface and retract the first and second latch members.

The foregoing and other features, utilities and advantages of the invention will be apparent from the following more particular description of various examples as illustrated in the accompanying drawings.

### BRIEF DESCRIPTION OF THE DRAWINGS

The accompanying drawings, which are incorporated in and constitute a part of this specification, illustrate various example embodiments, and together with the description, serve to explain the principles thereof. Like items in the drawings are referred to using the same numerical reference.

FIG. 1 is a perspective view of an example lock assembly in accordance with the present disclosure with latch members in an extended position.

FIG. 2 is a perspective view of the lock assembly of FIG. 1 with the latch members in a retracted position.

FIG. 3 is an exploded perspective view of the lock assembly of FIG. 1.

FIG. 4 is a front view of the lock assembly of FIG. 1.

FIG. 5 is a is a side view of the lock assembly of FIG. 1.

FIG. 6 is a cross-sectional view of the lock assembly as viewed about lines 5-5 in FIG. 5.

FIG. 7 is a cross-sectional view of the lock assembly as viewed about lines 7-7 in FIG. 4.

FIG. 8 is a perspective view of a portion of the lock assembly of FIG. 1.

FIG. 9 is a close-up view of a portion of the cross-sectional view of FIG. 7.

FIG. 10 is a close-up view of another portion of the cross-sectional view of FIG. 7.

FIG. 11 is cross-sectional view of the lock assembly as viewed about lines 11-11 in FIG. 6.

FIG. 12 is a close-up view of another portion of the cross-sectional view of FIG. 7.

FIG. 13 is a perspective view of another portion of the lock assembly of FIG. 1.

FIG. 14 is a partial cross-sectional view of the portion of the lock assembly as viewed about lines 14-14 in FIG. 13.

FIG. 15 is a perspective view of a portion of a door structure and enclosure to which the lock assembly of FIG. 1 may be mounted, the latches of the door assembly being in a retracted position.

FIG. 16 is a close-up side view of one end of the lock assembly of FIG. 15.

FIG. 17 is a close-up perspective view of the end of the lock assembly of FIG. 16.

FIG. 18 is a close-up side view of another end of the lock assembly of FIG. 15.

FIG. 19 is a close-up perspective view of the end of the lock assembly of FIG. 18.

FIG. 20 is a perspective view of a portion of a door structure and enclosure to which the lock assembly of FIG. 1 may be mounted, the latches of the door assembly being in an extended position.

FIG. 21 is a close-up side view of one end of the lock assembly of FIG. 20.

FIG. 22 is a close-up perspective view of the end of the lock assembly of FIG. 21.

FIG. 23 is a close-up side view of another end of the lock assembly of FIG. 20.

FIG. 24 is a close-up perspective view of the end of the lock assembly of FIG. 23.

FIG. 25 is a schematic perspective view of an example enclosure representatively shown in the form of a mobile storage trailer to which a door structure having the lock assembly of FIG. 1 mounted thereto.

FIG. 26 is a schematic front view of an example door assembly, which for representative purposes, includes a plurality of lock assemblies mounted thereto.

FIG. 27 is a schematic front view of an example door assembly having a plurality of lock assemblies embedded therein.

FIG. 28 is a perspective view of another example lock assembly in accordance with the present disclosure.

FIG. 29 is a front view of the lock assembly of FIG. 28.

FIG. 30 is a perspective view of a portion of the lock assembly of FIG. 28.

FIG. 31 is a perspective view of another portion of the lock assembly of FIG. 28.

FIG. 32 is a cross-sectional front view of the lock assembly of FIG. 28.

FIG. 33 is a perspective view of an example latch receiver in accordance with the present disclosure.

FIG. 34 is a front view of the latch receiver of FIG. 33.

FIG. 35 is a side view of the latch receiver of FIG. 33.

FIG. 36 is a perspective view of an example adapter bracket in accordance with the present disclosure.

FIG. 37 is a front view of the adapter bracket of FIG. 36.

FIG. 38 is a side view of the adapter bracket of FIG. 36.

FIG. 39 is a perspective view of an example mounting arrangement in which the latch receiver of FIG. 33 and adapter bracket of FIG. 36 are mounted to a portion of an enclosure assembly.

FIG. 40 is a perspective view of another example mounting arrangement in which the latch receiver of FIG. 33 and adapter bracket of FIG. 36 are mounted to a portion of an enclosure assembly.

FIG. 41 is a perspective view of a further example mounting arrangement in which the latch receiver of FIG. 33 is mounted to a portion of an enclosure assembly.

### DETAILED DESCRIPTION

The present application is directed to lock assemblies, portions of lock assemblies, lock assembly systems, and various methods of operating lock assemblies. The present disclosure is also directed to door structures and enclosures that include lock assemblies, and methods of operating and assembling door structures and enclosures that include lock assemblies. Other aspects of the present disclosure are directed to arrangement and operation of one or more lock assemblies with a door structure. Still further aspects of the present disclosure are directed to lock assemblies for use in locking an enclosure such as a trailer. The lock assembly may be mounted to or at least partially embedded in and operable with a door structure that is arranged to provide access to the enclosure. The example lock assembly disclosed herein may provide locking and unlocking of a door structure relative to an enclosure.

An example lock assembly may include an elongate housing assembly, at least one latch associated with an end portion of the housing assembly, at least one latch drive, and at least one actuator that interfaces the at least one latch and at least one latch drive. Operation of the latch drive causes the at least one latch to move between extended and retracted positions. In one example, the at least one actuator includes a lead screw operably coupled to the latch drive and a lead screw guide that receives the lead screw. In at least one example, the lead screw guide may be a nut member having a threaded bore that threadably engages threads along an outer surface of the lead screw. In some arrangements, the lock assembly portion includes first and second latches, wherein the first latch is associated with a first end portion of the housing assembly and the second latch is associated with a second, opposite end portion of the housing assembly. Operation of the latch drive causes the first and second latches to move relative to one another between respective extended and retracted positions. In some arrangements, the housing assembly includes first and second housing members that are movable relative to each other. Some examples include an extension member for selectively varying an effective length of the housing assembly.

In some example arrangements, the lock assembly may include a latch receiver associated with each of the latches of the lock assembly. The lock assembly may be operable to move the latches into and out of engagement with a respective latch receiver. In at least one example, the latch receivers are mounted to an enclosure, the remaining portions of the lock assembly are mounted to a door structure and the latches of the lock assembly are operable to engage the latch receivers to maintain the door structure in a closed position relative to the enclosure.

Example door structures for use with the example lock assemblies described herein may include an inside or inner surface and an opposite outside or outer surface. Some door structures may further define at least one cavity or passageway at a location spaced between the inner and outer surfaces. When the door structure is used in conjunction an enclosure having an interior, the inside surface of the door structure faces into the interior when the door is in a closed position. Typically, the lock assembly is positioned inward of the outer surface of the door structure. In one example, at least portions of the lock assembly are mounted on the inside surface of the door structure. In other arrangements, at least portions of the lock assembly are positioned within the inner cavity or passageway of the door structure. Typically, the lock assembly is positioned relative to the outer surface of the door structure and the enclosure to which the door structure is mounted so as to be inaccessible from outside of the enclosure when the door structure is in a closed position.

Other aspects of the present disclosure are directed to use of a single latch drive to operate more than one latch of a lock assembly. In at least one example, a single latch drive actuates a pair of latches to travel in opposite directions from each other to extend the latches away from one another toward respective extended and retracted positions, and to travel towards each other into respective retracted positions. Other aspects of the present disclosure are directed to a lock assembly with at least two latch members, wherein the lock assembly is operable to center itself relative to the enclosure as latch members of the lock assembly engage with and disengage from respective latch receivers mounted to the enclosure. In at least some arrangements, as will be described in further detail below, the latch members of the lock assembly may move in unison between retracted and extended positions. In another example, the latch members move in series wherein one latch member moves from a retracted to an extended position prior to the other latch member beginning to move from its retracted position to its extended position. In a still further example, the latches move in a step sequence of motion wherein one latch member moves from a retracted position to a position less than the fully extended position, followed by some movement of the other latch member from its retracted position toward its fully extended position, and so on until both latch members reach an extended state. Retraction of the latch members from extended positions to retracted positions may occur in similar patterns of movement.

A further aspect of the present disclosure relates to lock assemblies that include a single latch member. Such lock assemblies may include a housing assembly, a latch, at least one latch drive, at least one actuator, and at least one latch receiver. In at least one example, a portion of the housing assembly is fixed relative to a substrate (e.g., a door structure) and another portion of the housing assembly carries the latch and is movable relative to the fixed portion of the housing assembly.

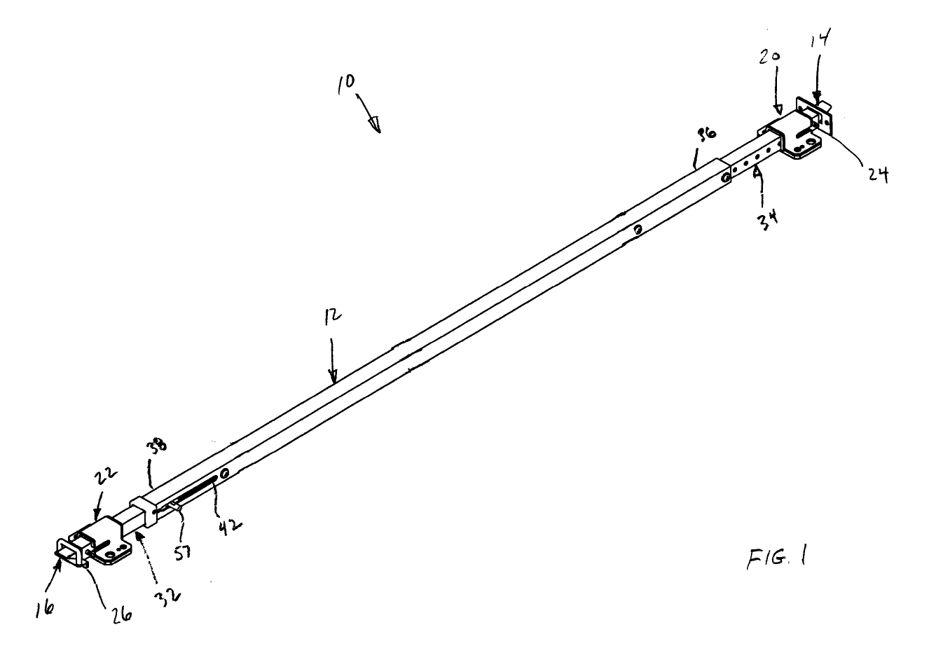

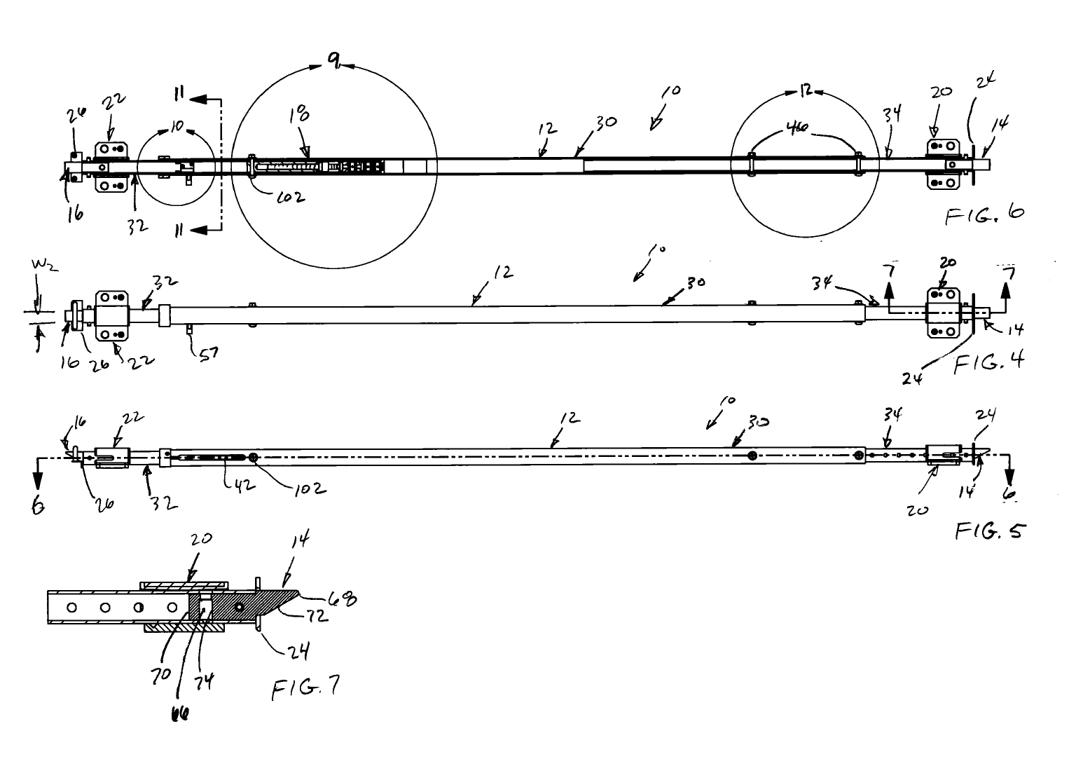

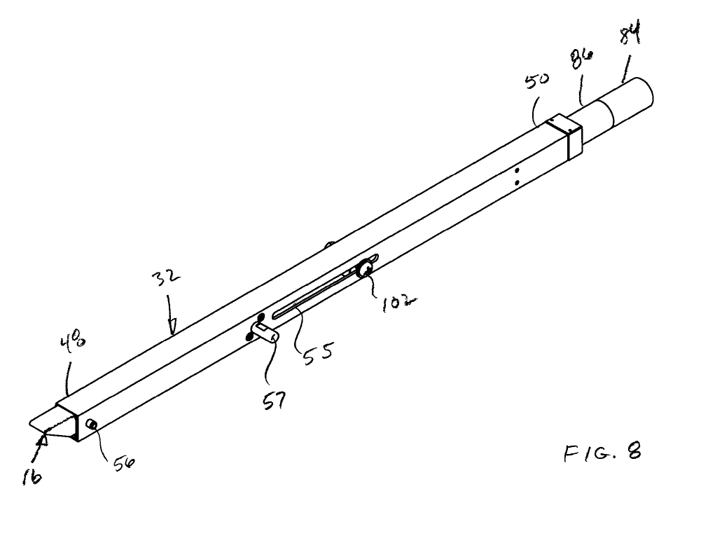

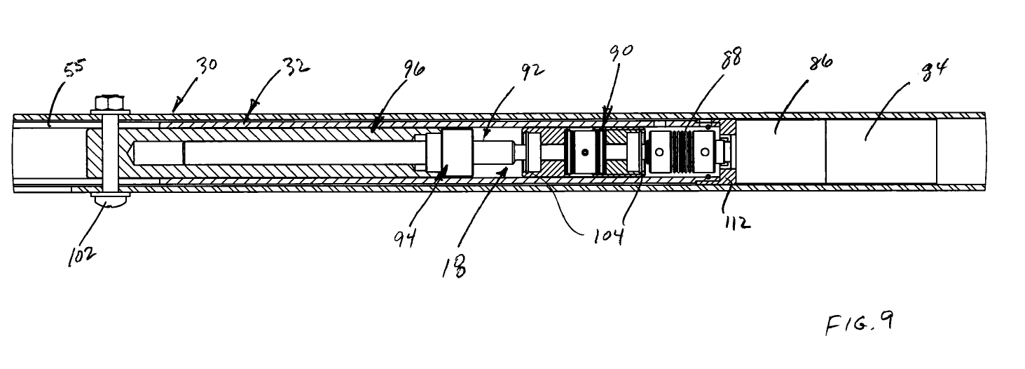

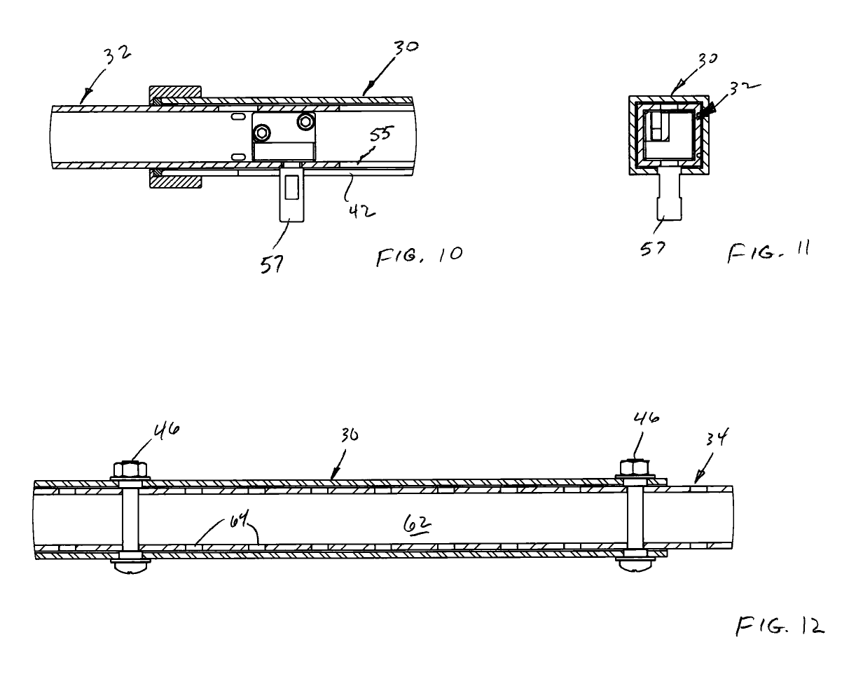

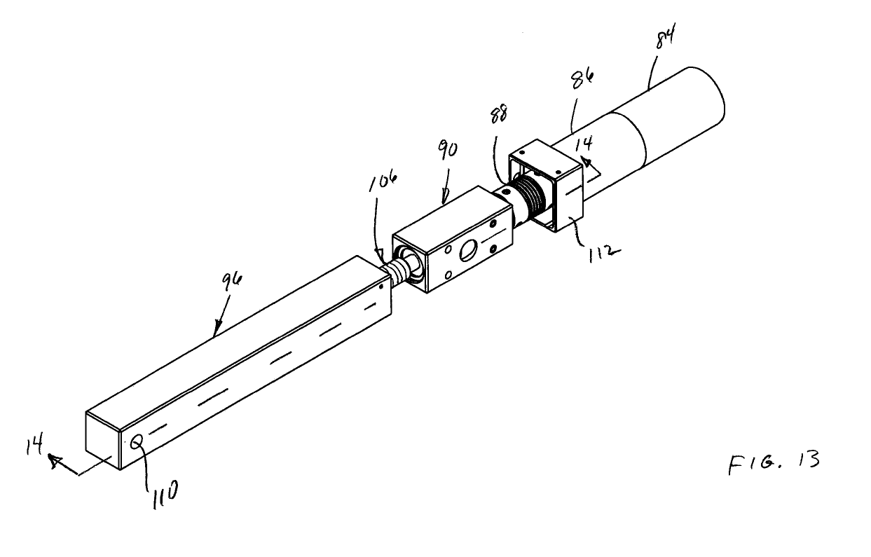

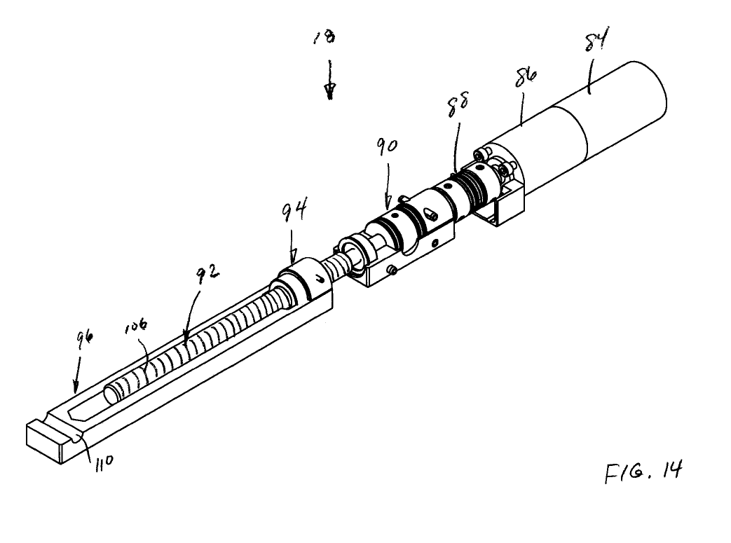

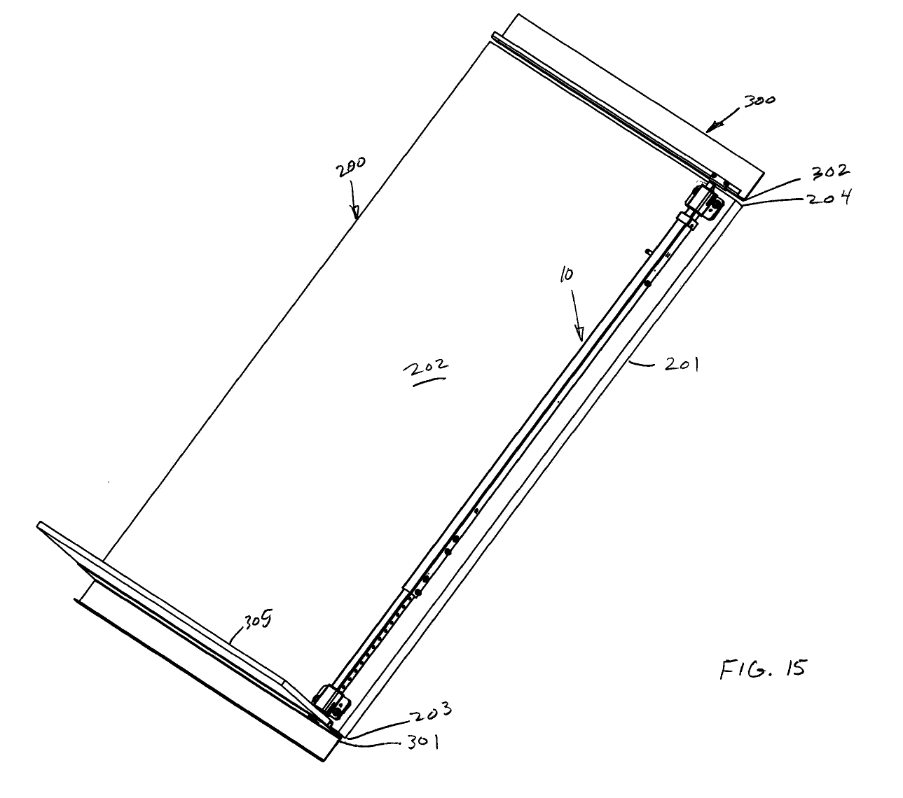

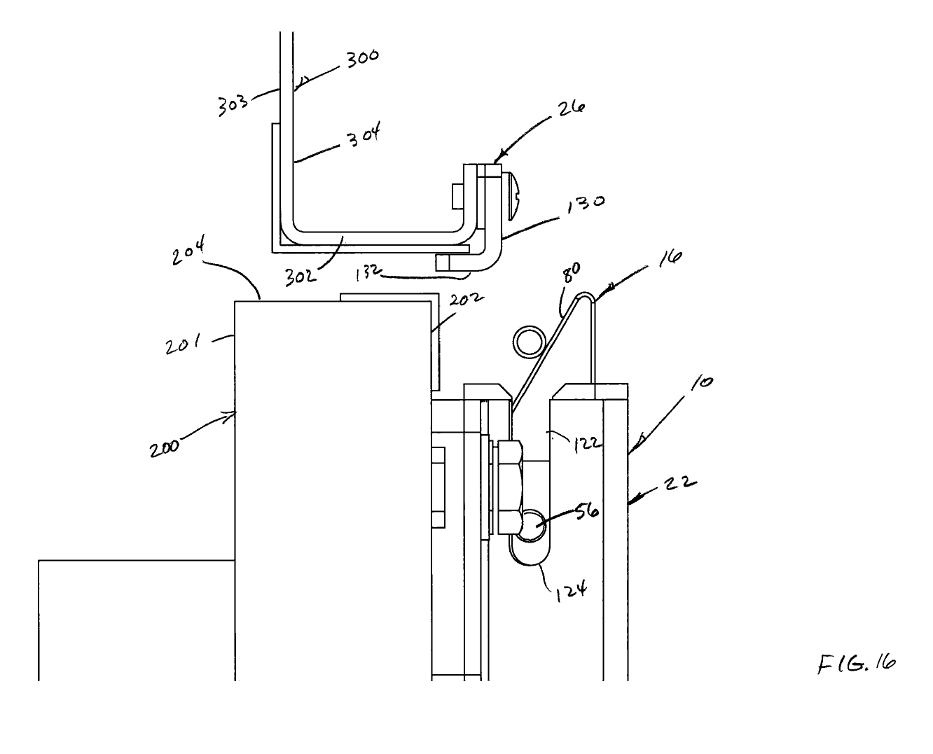

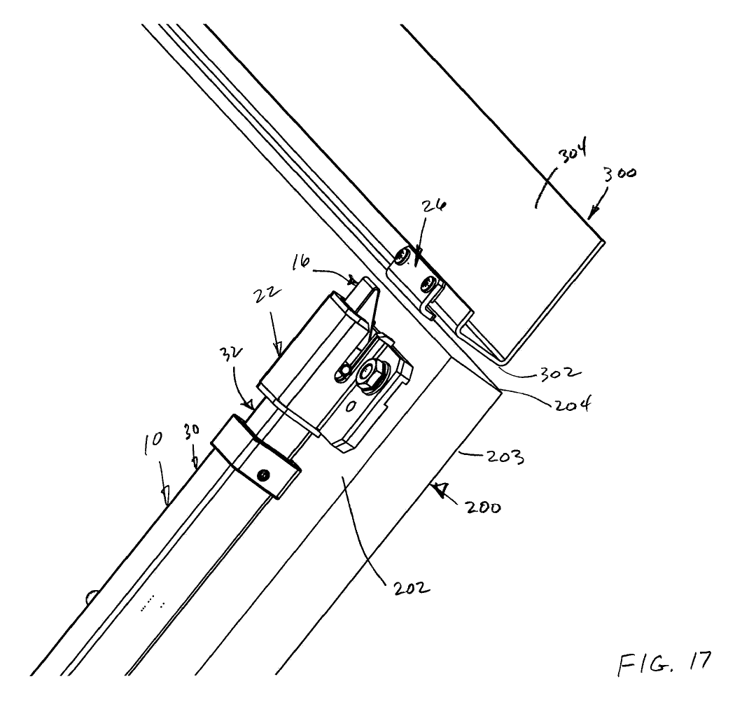

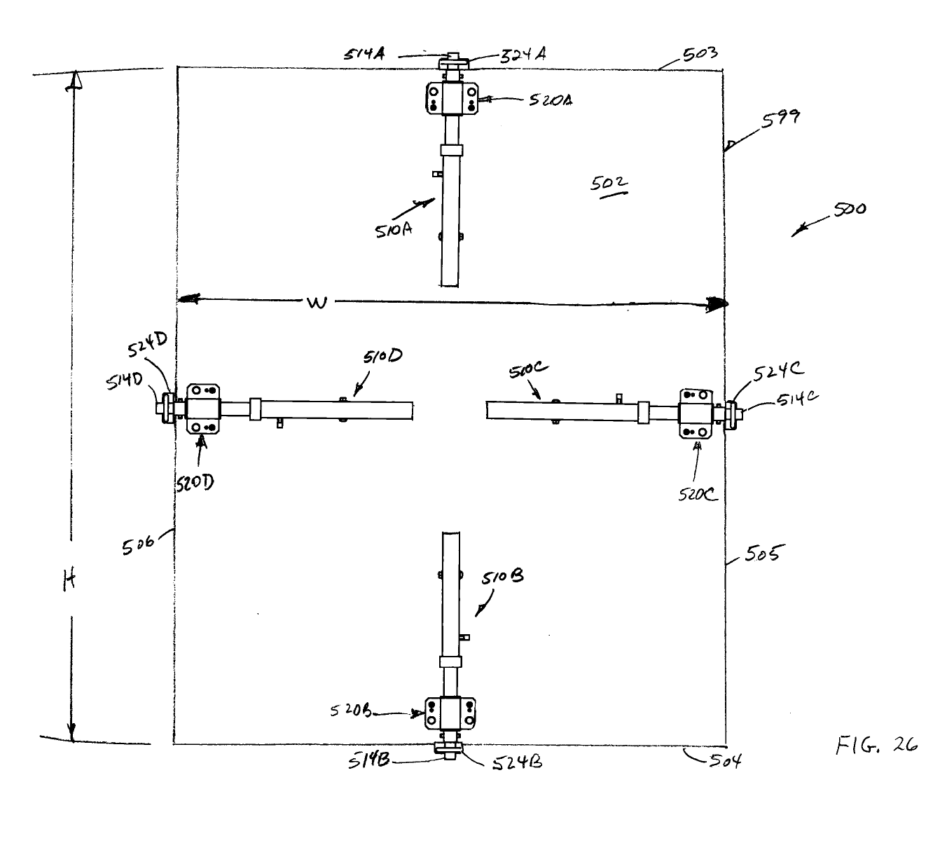

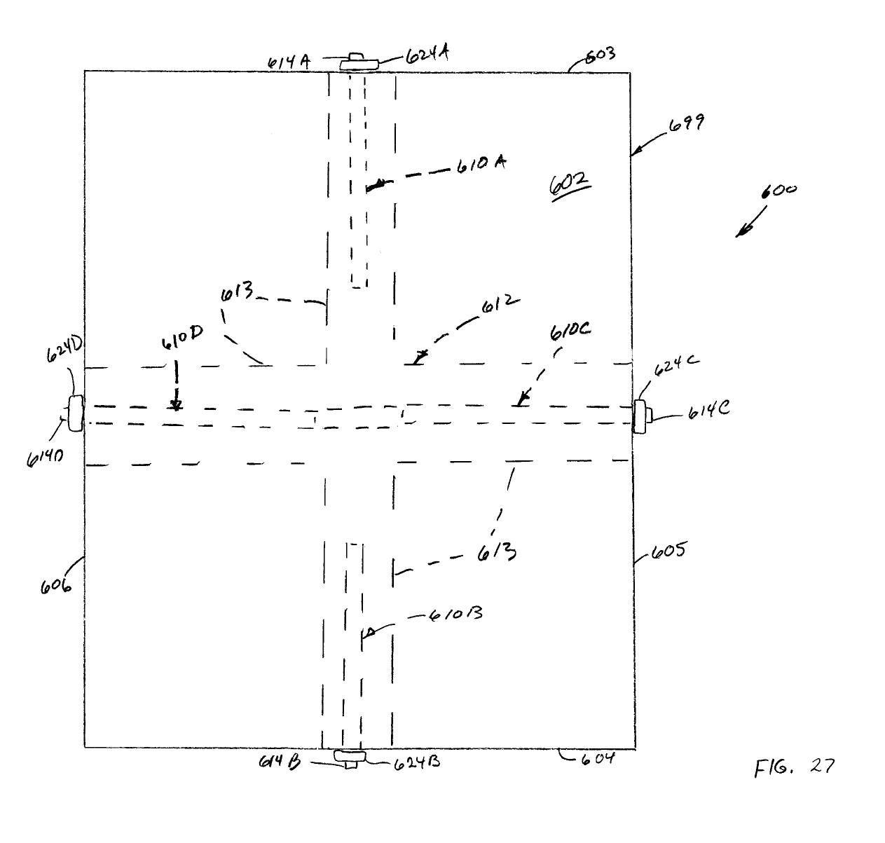

The following description related to FIGS. 1-14 is directed to an example lock assembly 10. The description that follows related to FIGS. 15-25 is directed to the lock assembly 10 is in use with portions of a door structure and portions of an enclosure. The following description related to FIGS. 26-27 schematically illustrates additional exemplary arrangements of one or more lock assemblies relative to a door structure.

Referring now to FIGS. 1-14, an example lock assembly 10 includes a housing assembly 12, a first latch 14, a second latch 16, a drive assembly 18, first and second housing bracket assemblies 20, 22, and first and second latch receivers 24, 26.

The housing assembly 12 may include a first housing 30, a second housing 32 and an extension member 34. In at least one arrangement, the first and second housings 30, 32 are moveable relative to each other upon activation of the drive assembly 18. The drive assembly 18 may be arranged to provide a predetermined amount of movement between the first and second housing 30, 32.

The extension member 34 may be adjustably mounted to at least one of the first or second housing 30, 32 to provide an adjustable effective length of the housing assembly 12. In one example, the extension member 34 is connected to the first housing 30 so that the first housing 30 and extension member 32 move relative to the second housing 32 upon activation of the drive assembly 18. While the extension member 34 is shown in the figures extending from one end of the first housing 30, other arrangements may include positioning of the extension member 34 between spaced apart segments of one of the housing members 30, 32 to alter an effective length of the housing assembly 12 or an effective length of the particular first or second housing member 30, 32 to which the extension member 34 is mounted.

The first housing 30 includes first and second ends 36, 38, an interior 40, a track 42 defined in at least one sidewall at a location between the first and second ends 36, 38, and a length adjustment aperture 44 sized to receive an extension connector 46. The interior 40 is sized to receive portions of the second housing 32 and extension member 34. The extension member 34 may be inserted into the first end 36. The second housing 32 may be inserted into the second end 38.

The first housing 30 may include the plurality of length adjustment apertures 44 spaced apart locations along a length of the first housing 30. A plurality of extension connectors 46 may be inserted into corresponding length adjustment apertures 44. As shown for example in FIG. 6, the extension connectors 46 may be inserted through corresponding connector apertures of the extension member 34 such that the extension connectors 46 extend through at least portions of the first housing 30 and extension member 34 to provide a connection therebetween.

The interior 40 may also be sized to receive at least portions of the drive assembly 18. In at least one example, the drive assembly is substantially entirely enclosed within the first housing 30. The first housing 30 may include a substantially rectangular cross-sectional shape as shown in FIG. 11. Other cross-sectional shapes and sizes are possible for the first housing 30.

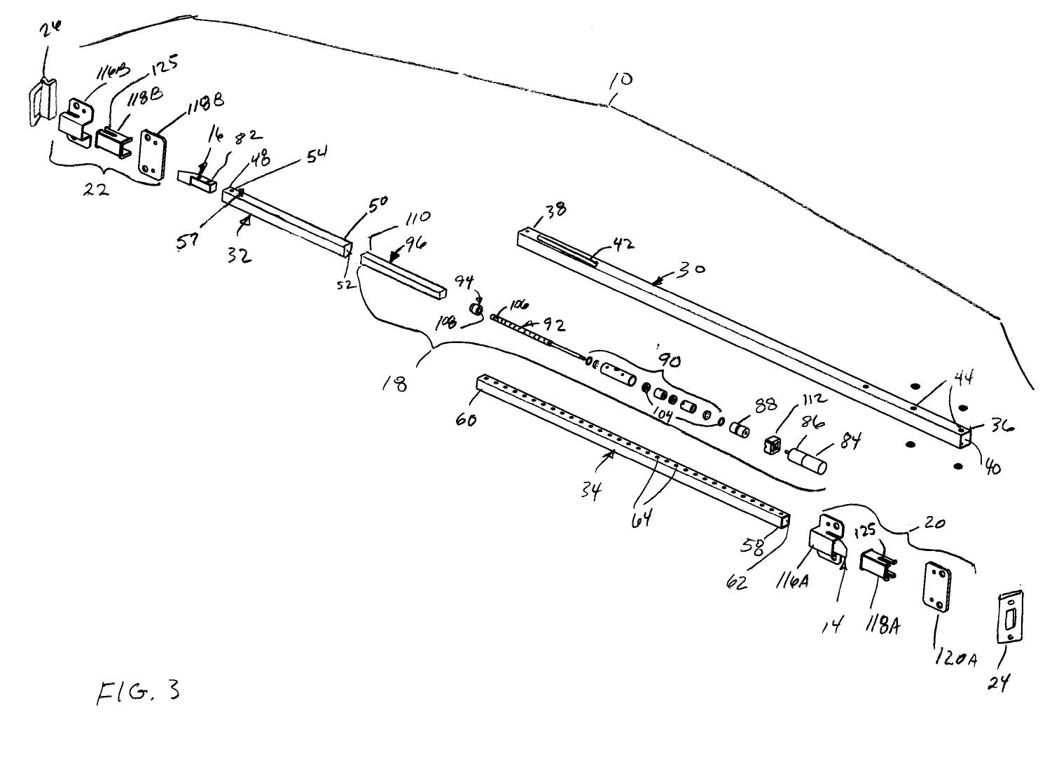

The second housing 32 includes first and second ends 48, 50, an interior 52, at least one latch connector aperture 54, at least one slot feature 55, at least one second latch connector 56, and at least one electrical connector 57 (see FIGS. 3 and 8). The interior 52 of the second housing 32 may be sized to receive portions of the second latch 16. In at least some arrangements, the interior 52 may also be sized to receive portions of the drive assembly 18. In other arrangements, the second housing 32 may be a substantially solid member without an interior, wherein the second latch 16 and drive assembly 18 are configured for receiving portions of the second housing 32 as an insert as part of connecting the second housing 32 to the second latch 16 and drive assembly 18.

The latch connector aperture 54 may be arranged to align with a connector aperture of the second latch 16 so that the second latch connector 56 can extend at least partially through the connector apertures to provide a connection between the second housing 32 and second latch 16. Similar connector apertures and latch connectors may be used for connection of the second housing 32 to the drive assembly 18.

The slot 55 may be positioned along a single side surface of the second housing 32 at a location between the first and second ends 48, 50. In some arrangements, a pair of slots 55 may be positioned on opposing side surfaces of the second housing 32. The slot 55 is aligned with a nut housing connector 102 that extends from the drive assembly within the first housing 30 to an outer surface of the first housing 30 to provide a connection between the first housing 30 and the drive assembly 18. The slot 55 may permit longitudinal travel of the first housing 30 and drive assembly 18 relative to the first housing 32.

The electrical connector 57 may extend from a side surface of the first housing 32 at a location spaced between the first and second ends 48, 50. The electrical connector 57 extends through the track 42 of the first housing 30 when the lock assembly 10 is assembled. The track 42 provides the electrical connector with an unobstructed path in the axial direction as the first and second housings 30, 32 move relative to each other. Typically, the track 42 has sufficient length that the electrical connector 57 does not contact one of the opposing ends of the track 42 during the typical relative axial movement between the first and second housings 30, 32. As noted herein, the amount of relative axial movement between the first and second housings is defined by contact between extension member 34 and first latch receiver 24 and contact between second housing 32 and second latch receiver 26, or contact between nut housing connector 102 and ends of the slot 55 defined in second housing 32.

In at least some arrangements, the electrical connector 57 may be configured for attachment to a wire harness or other component that provides an electrical connection to, for example, a controller (e.g., controller 405 discussed below with reference to trailer 400) that controls at least some operation of the lock assembly 10. The electrical connector 57 may also be electrically connected to at least one wire member that extends from the motor 84 within the first housing 30 to the electrical connector 57.

The second housing 32 may have a generally rectangular cross-sectional shape as shown in FIG. 11. In at least one example, the cross-sectional shape of the second housing 32 is substantially the same as the cross-sectional shape of first housing 30. A maximum outer dimension (i.e., width and height) of the second housing 32 are typically slightly smaller than a corresponding minimum inner dimension (i.e., inner width and height) of the first housing 30 (see FIG. 11). Other cross-sectional shapes and sizes are possible for the second housing 32, including, for example, circular, oval, and hexagonal shapes. In at least one example, at least one of the cross-sectional shapes of the inner or outer surface of the second housing 32 is different from the cross-sectional shape of a respective inner or outer surface of the first housing 30.

The extension member 34 includes first and second ends 58, 60 and interior 62, and at least one connector aperture 64 through which at least one first latch connector 66 may be received. The interior 62 may be configured to receive a portion of the first latch 14 at the first end 58. At least one of the connector apertures 64 is arranged for alignment with a corresponding connector aperture of the first latch 14 to receive at least a portion of the first latch connector 66 to provide a connection between the extension member 34 and the first latch 14. A second end 60 of the extension member 34 may be received into the interior 40 of the first housing 30 at the first end 36. The connector apertures 64 may be sized and arranged to align with at least one of the length adjustment apertures 44 of the first housing 30. The aligned length adjustment apertures 44 and at least one of the connector apertures 64 may receive an extension connector 46 for connection of the first housing 30 to the extension member 34. The attached figures illustrate a pair of extension connectors 46 inserted through a pair of length adjustment apertures and connector apertures 64. Removing the extension connectors 46 and adjusting a position of the extension member 34 relative to the first housing 30 can be done to adjust an effective length between a second end 38 of the first housing 30 and the first end 58 of the extension member 34.

At least FIG. 3 illustrates a rectangular cross-sectional shape for the extension member. Typically, the cross-sectional shape of the extension member 34 is substantially similar to a cross-sectional shape of the first housing 30. Further, maximum dimensions of an outer surface of the extension member 34 (i.e., width and height) is typically slightly smaller than a minimum cross-sectional dimension of an inner surface of the first housing 30. In other arrangements, the cross-sectional shape of at least portions of the extension member 34 may be different from the cross-sectional shape of the first housing 30.

In some arrangements, the interior 62 of the extension member 34 may be sized to receive a portion of the first housing 30 such as the first end 36. The first latch 14 may be configured to receive at least portions of the extension member 34 (i.e., the first end 58) rather than the first latch 14 being inserted into the interior 62 of the extension member 34.

Each of the first housing 30, second housing 32, and extension member 34 may have a substantially constant cross-sectional shape and size along each of their respective lengths. In other arrangements, a cross-sectional shape or size of any one of the first and second housing 30, 32 and extension member 34 may vary along its respective length.

The housing assembly 12 may include additional components. For example, any one of the first and second housing 30, 32 and extension member 34 may include multiple segments that are connected together either permanently or adjustably. In one arrangement, the housing assembly 12 may include only the first and second housings 30, 32 and be devoid of an extension member such as extension member 34. In such an arrangement, the first latch 14 may be mounted directly to the first housing 32 at, for example, the first end 36. Other aspects of the lock assembly may provide for a length adjustment that adjusts an effective length of the housing assembly such as, for example, connection points between the housing members 30, 32 and at least one of the first and second latches 14, 16. Various terms such as housing, housing assembly, latch, extension and lock as used herein are merely used as terms to distinguish between components and are not intended to be limiting to any specific term definition.

In still further arrangements, the housing assembly may include only the first housing 30. In such an arrangement, the first latch 14 may be mounted directly to the first end 36 of the first housing 30. The second latch 16 is directly mounted to the drive assembly 18, wherein the drive assembly 18 when actuated provides relative movement between the first and second latches 14, 16.

In still further arrangements, the lock assembly may be void of a housing assembly that encloses the drive assembly. In such an arrangement, one end of the drive assembly may be connected to the first latch 14 and an opposing end of the drive assembly may be connected to the second latch 16. Activation of the drive assembly may provide relative movement of the first and second latches 14, 16 between respective extended and retracted positions.

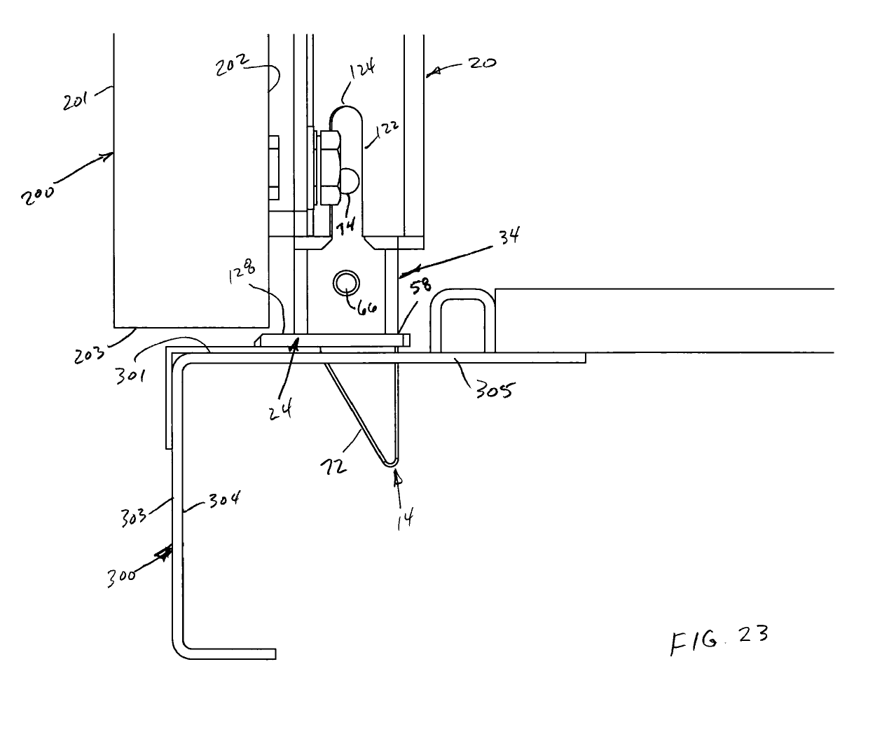

Referring now to FIGS. 7 and 23, the first latch 14 is shown having a distal end 68, a proximal end 70, a tapered surface 72, and at least one connector aperture 74. The distal end 68 is arranged to extend into and out of contact with the first latch receiver 24. The proximal end 70 is connected to the extension member 34. In at least one arrangement, the proximal end 70 is inserted into an interior 62 at the first end 58 of the extension member 34. The connector apertures 74 may be aligned with connector apertures 64 of the extension member 34 and arranged to receive the first latch connector 66. At least a portion of the first latch connector 66 may extend outward from peripheral surfaces of the first latch 14. These protruding portions of the first latch connector 66 may be arranged to engage with portions of the first housing bracket assembly to limit movement of the first latch 14 in a retracted direction relative to the first latch receiver 24.

The tapered surface 72 typically defines an engagement surface for contact between the first latch 14 and surfaces of the first latch receiver 24 that define the latch opening 126 when inserting the first latch 14 into the first latch receiver 24. The tapered surface 72 defines a reduced dimension (i.e., reduced thickness or width dimension) of the first latch 14 at the distal end 68, which end 68 is inserted into the first latch receiver 24. The reduced dimension at first end 68 may provide for easier insertion and alignment of the first latch 14 relative to the first latch receiver 24.

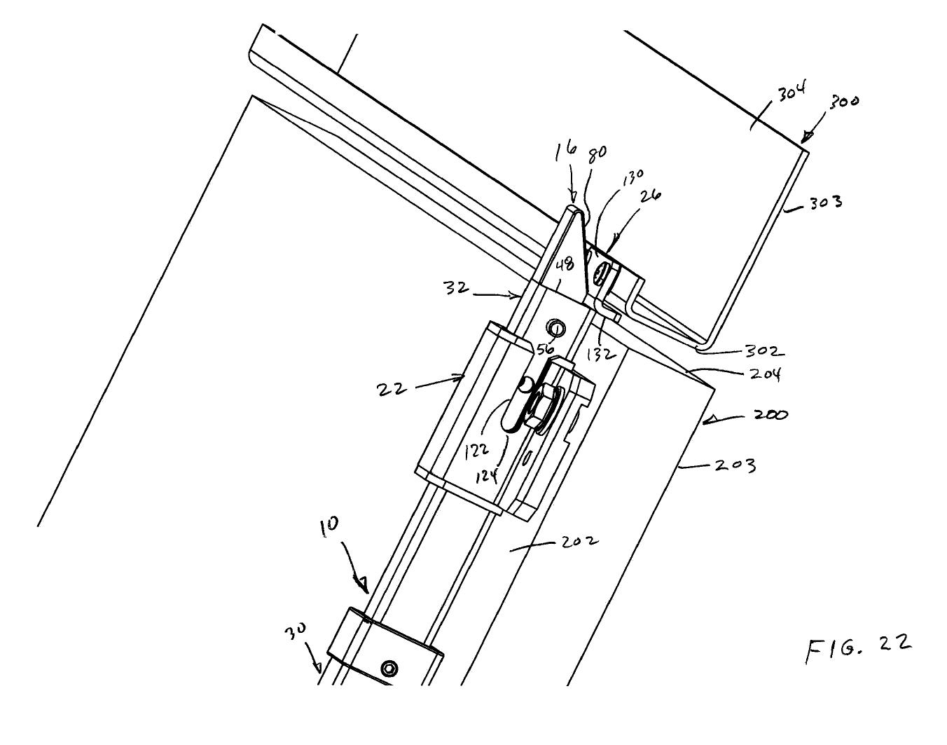

Referring now to FIGS. 8 and 21, the second latch 16 includes a distal end 76, a proximal end 78, a tapered surface 80, and at least one connector aperture 82. The second latch 16 may be constructed to have substantially the same shape, size and function as the first latch 14 described above.

The distal end 76 of the second latch 16 is arranged to extend into and out of engagement of contact with the second latch receiver 26. The proximal end 78 is connected to the second housing 32. In at least one example, the proximal end 78 is inserted into the interior 54 of the second housing 32. At least one of the connector apertures 82 may be aligned with the latch connector aperture 54 of the second housing 32 and configured to receive at least one second latch connector 56 for connection of the second latch 16 to the second housing 32. In other arrangements, the second latch 16 may be sized to receive a portion of the second housing (i.e., the second end 50), rather than being inserted into the second housing 32 for connection to the second housing 32.

The tapered surface 80 typically defines an engagement surface for contact between the second latch 16 and a latch opening or latch contact surface of the latch receiver 26. Similar to the tapered surface 72 of the first latch 14, the tapered surface 80 may define a smaller maximum dimension for the second latch 16 at the distal end 76 for easier insertion into and alignment of the second latch 16 relative to the second latch receiver 26.

The cross-sectional shape and size of the first and second latches 14, 16 may be substantially rectangular. Other cross-sectional shapes and sizes of the first and second latches 14, 16 are possible. For example, at least a portion of the first and second latches 14, 16 may be generally circular in cross-sectional to mate with, for example, a generally circular interior cross-sectional shape of the extension member 32 and second housing 32.

The first and second latches 14, 16 are shown in the figures as features separate from the housing assembly 12. In other arrangements, it may be possible to integrate latches 14, 16 directly into the housing assembly. In one example, a tapered surface is formed in an end portion of the housing assembly by, for example, cutting, casting, or molded to define a tapered surface that functions as a latch member. It may also be possible to connect the first and second latches 14, 16 to the housing assembly 12 in a more permanent fashion than by using latch connectors 56, 66, which are typically removable in nature. In at least one example, the first and second latches 14, 16 may be welded, bonded, adhered, or in other ways permanently attached to the housing assembly 12. In other arrangements, it may be possible to directly connect the at least one of the first and second latches 14, 16 to the drive assembly 18 without a housing member positioned therebetween. Alternatively, features of at least one of the first and second latches 14, 16 may be provided as a component of the drive assembly 18.

The drive assembly 18 is now described with reference to FIGS. 3, 6, 9, 13 and 14. The drive assembly 18 includes a motor 84 (also referred to herein as a latch drive), a gear box 86, a motor coupling 88, a bearing assembly 90, a lead screw 92, a nut 94 (also referred to herein as a lead screw guide), a nut mount (also referred to herein as a lead screw guide mount 96), and a nut housing connector 102 (also referred to herein as a lead screw guide housing connector). The bearing assembly 90 may include a plurality of bearing members 104. The lead screw 92 may include a plurality of external threads 106. The nut 94 may include a threaded bore 98. The nut mount 96 may include a connector aperture 110 that is sized to receive the nut housing connector 102.

The motor 84 may be configured to provide a rotational output. A rotational output of the motor 84 may be appropriately geared via a gear ratio of the gear box 86 to provide an increase or decrease in the amount of torque applied to the lead screw 92 via the motor coupling 88 and bearing assembly 90. The threads 96 of the lead screw 92 threadably engage with the threaded bore 108 of the nut 94. The nut 94 is maintained in a fixed rotational position within the nut mount 96. The nut mount 96 is fixed to the first housing 30 via the nut housing connector 102 (see FIG. 9). The second end 50 of the second housing 32 is connected to the drive assembly 18 via a second housing coupling member 112 (see FIGS. 9 and 13). Thus, as the drive assembly is actuated to move the nut 94 along the lead screw 92, the first and second housings 30, 32 travel in the longitudinal direction relative to each other.

As noted above, substantially all of the drive assembly 18 is positioned within the first housing 30. At least some portions of the drive assembly 18 may also be positioned within the second housing 32. In other arrangements, any portion of the drive assembly 18 may be arranged outside of either of the first and second housings 30, 32. In at least one example, portions of the drive assembly are interposed between an outer surface of the second housing 32 and an inner surface of the first housing 30.

In some arrangements, the lead screw 92 and nut 94 are together referred to as an actuator of the lock assembly 10. In one example, the lock assembly includes a housing assembly, first and second latches, a motor and an actuator, wherein operation of the motor causes the actuator to move the first and second latches relative to each other. Other types of actuators are possible for use in the drive assembly in addition to or in place of the combined lead screw and nut configuration illustrated in the figures. Many other drive systems are possible for axially moving a latch member relative to a housing, or to move first and second latches between extended and retracted positions relative to each other. Some example drive systems include belt, chain, rack and pinion, and gear drives. Thus the term “actuator” broadly contemplates whatever structure that interfaces the drive assembly to the latches and responds to activation of the drive assembly to cause the latches to move relative to one another.

Other drive assembly arrangements may include more than one motor or other driving device. For example, a separate motor may be used to move respective first and second latches of the lock assembly. In some arrangements, a single motor may be used to actuate more than first and second latches, such as, for example, three or more latches between extended and retracted positions.

The lock assembly 10 provides for traveling of the first and second latches 14, 16 in generally the same plane of motion. The first and second latches 14, 16 may also move along the same axis of motion whether moving in the same direction or in opposite directions toward or away from each other. In some arrangements, the first and second latches 14, 16 may move coaxially relative to each other. In other arrangements, the first and second latches may have directions of motion that are out of plane. The first and second latches may move in directions that are non-coaxial but within the same plane (i.e., in directions of motion that spaced apart laterally but parallel). First and second latches 14, 16 may move in directions of motion that are angled relative to each other such as, for example, in directions perpendicular to each other (e.g., see FIGS. 26 and 27).

The first and second housing bracket assemblies 20, 22 are now described with reference to FIGS. 1, 3, 16 and 18. The first housing bracket assembly 20 includes a bracket outer member 116A, a bracket insert 118A, and a bracket base 120A. The bracket outer member 116A may include a connector slot 122 having a length that determines a limit stop 124. The bracket insert 118A may also include a corresponding slot 125. The slots 122, 125 may be open at a distal end surface of the first housing bracket assembly 20.

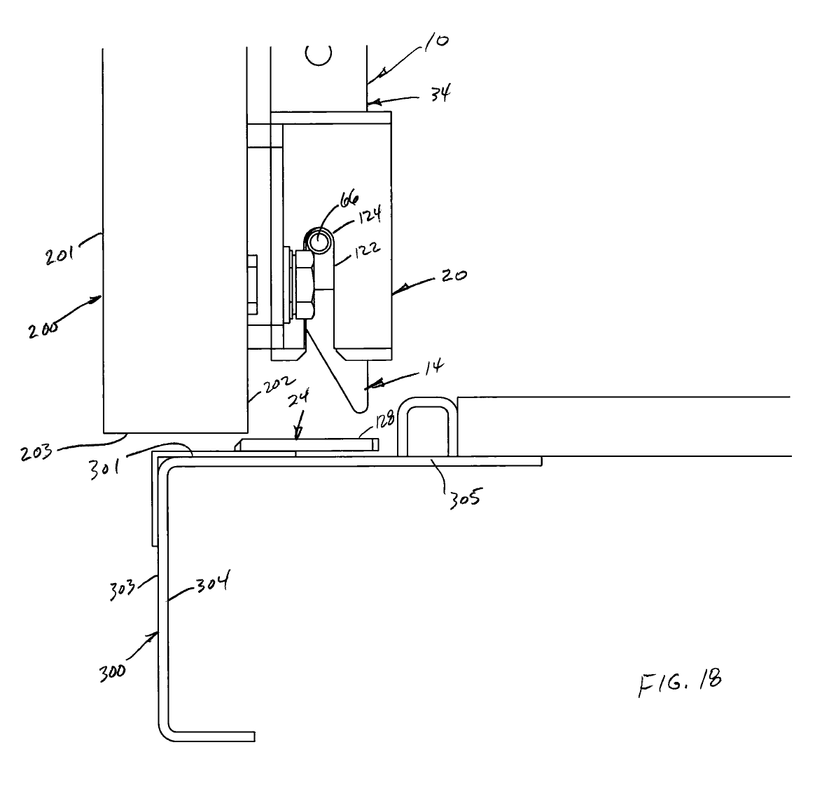

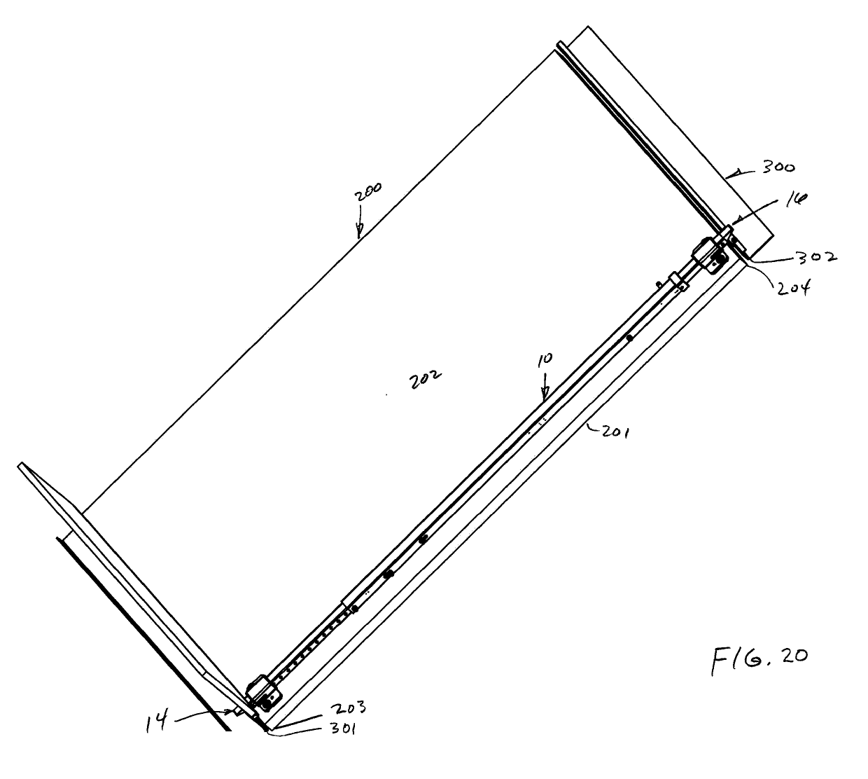

The second housing bracket assembly 22 includes a bracket outer member 116B, a bracket insert 118B, and a bracket base 120B. The bracket outer member 116B may include a connector slot 122 having a length that determines a limit stop 124. The bracket insert 118B may include a corresponding slot 125. The slots 122, 125 of the second housing bracket assembly 22 may be open at a distal end surface thereof. The slots 122, 125 are arranged to receive portions of the first and second latch connectors 66, 56 that are protruding from side surfaces from the extension member 34 and second housing 32, respectively. Referring to FIGS. 16 and 18, the latch connectors 66, 56 travel into and out of respective slots 122, 125 and be constrained by the limit stop 124 to limit retracted movement of the first and second latches 14, 16, relative to the first and second latch receivers 24, 26.

The bracket inserts 118A, 118B are sized to be inserted into the bracket outer members 116A, 116B. An internal space defined between the bracket insert 118A, 118B and the bracket base 120A, 120B has a size and shape that substantially matches an external cross-sectional size and shape of the corresponding portion of the housing assembly that is inserted therein. Extension member 34 extends through the first housing bracket assembly 22. The second housing 32 extends through the second housing bracket assembly 22 (see FIG. 1).

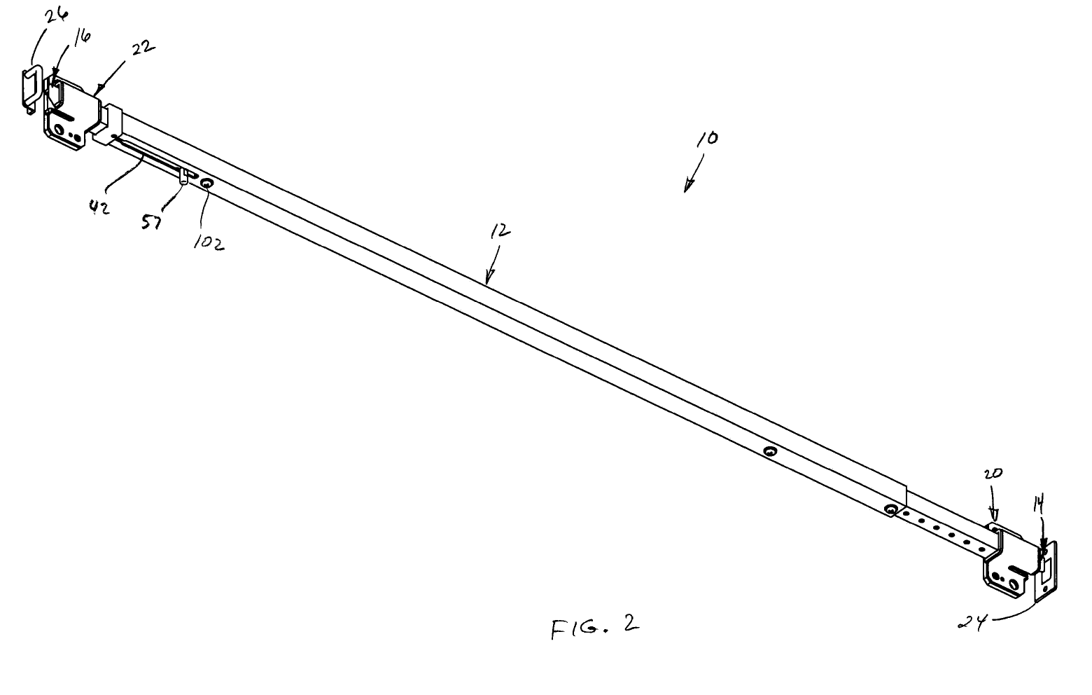

The first and second bracket assemblies 20, 22 may define an internal size and shape that provide for sliding engagement with the extension member 34 and second housing 32, respectively, which permits movement of the first and second latches 14, 16 from the retracted position shown in FIG. 2 to the extended position shown in FIG. 1 and back to the retracted position shown in FIG. 2. Some friction may exist between the housing bracket assemblies 20, 22 and the extension member 34 and second housing 32. The amount of such friction may vary for each of the housing bracket assemblies 20, 22. The amount of friction that exists between the housing bracket assemblies 20, 22 and the extension member 34 and second housing 32 may influence which of the first and second latches 14, 16 moves first relative to the first and second latch receivers 24, 26 upon activation of the motor.

The first and second housing bracket assemblies 20, 22 are constructed to mount to a substrate or other mounting surface, such as, for example, a door structure. In at least some arrangements, the first and second housing bracket assemblies 20, 22 are the sole point of contact between the lock assembly 10 and the door structure. The housing assembly 12 may be maintained spaced apart from the door structure and free floating to slide within the first and second housing bracket assemblies 20, 22. Movement of the housing assembly 12 relative to the first and second housing bracket 20, 22 may be limited in one axial direction by the limit stop 124 engaging the first and second latch connector 66, 56. Movement of the housing assembly 12 relative to the first and second housing bracket assemblies 22 in the opposite direction (i.e., in the extended direction toward the first and second latch receivers), may be limited by contact of the extension member 34 and second housing 32 with portions of the first and second latch receivers 24, 26, respectively (see FIGS. 21 and 23).

Other housing bracket assembly constructions are possible for use with the housing assembly 10. Other arrangements may include more or fewer housing bracket assemblies than the two shown in the figures. For example, additional housing bracket assemblies may be positioned along the length of the housing assembly 12 such as, for example, along the length of the first housing 30. Alternatively, a single elongate housing bracket assembly may be used at any desired location along the length of the housing assembly 12 for mounting of the lock assembly to a substrate.

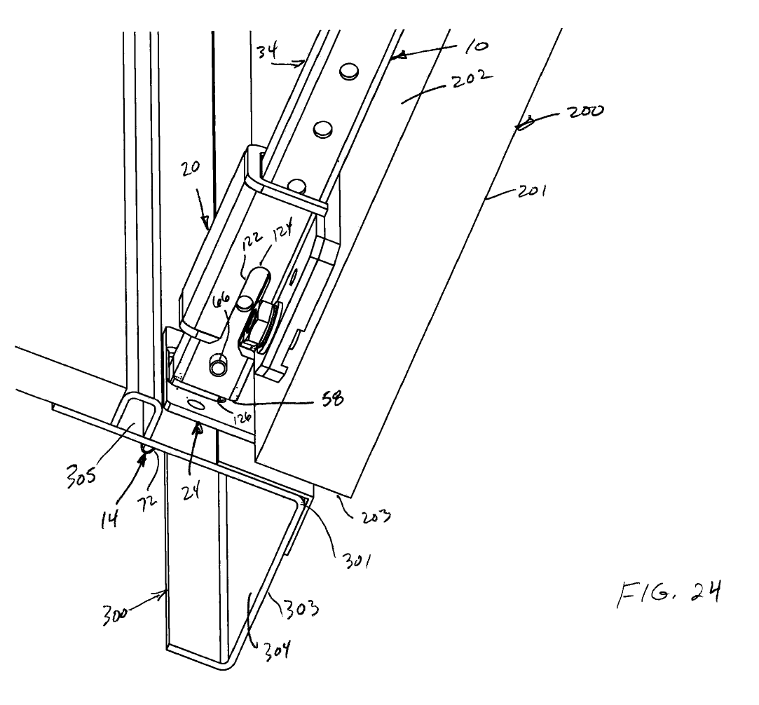

The first and second latch receivers 24, 26 are described in further detail with reference to FIGS. 1 and 16-19. The first latch receiver 24 includes a latch opening 126 and a first housing contact surface 128. Typically, the latch opening 126 is sized to receive at least a portion of the first latch 14 to extend therethrough when in the extended position. In at least one example, a first end 58 of the extension member 34 contacts the first housing contact surface 128 when the first latch 14 is fully extended (see FIGS. 23 and 24). In other arrangements, the first latch 14 may include a feature such as a step or shoulder feature that contacts the first housing contact surface 128 when the first latch 14 is fully extended.

The second latch receiver 26 includes a latch contact surface 130 and a second housing contact surface 132. In at least one arrangement, the surfaces 120, 132 are arranged generally perpendicular to each other. Alternatively, the second latch receiver 26 may include a latch opening similar in size and construction to the latch opening 126 of the first latch receiver 24. Likewise, the first latch receiver 24 may include a latch contact surface similar to latch surface 130 in place of or in combination with the latch opening 126.

The latch contact surface 130 is arranged to contact the second latch 16 as the second latch 16 moves from its retracted to its extended position. When the second latch 16 is in the extended position, the second end 50 of the second housing 32 contacts the second housing contact surface 132. In some arrangements, the second latch 16 may include a step or shoulder feature that contacts the second housing contact surface 132 when the second latch 16 is in a fully extended position, thereby limiting movement of the second latch 16 in a further extended direction.

The first and second latch receivers 24, 26 are typically mounted to surfaces of an enclosure or other mounting surface that is separate from the substrate (i.e., a door structure) to which the remaining portion of the lock assembly 10 (i.e., the housing assembly 12 and housing bracket assemblies 20, 22) are mounted.

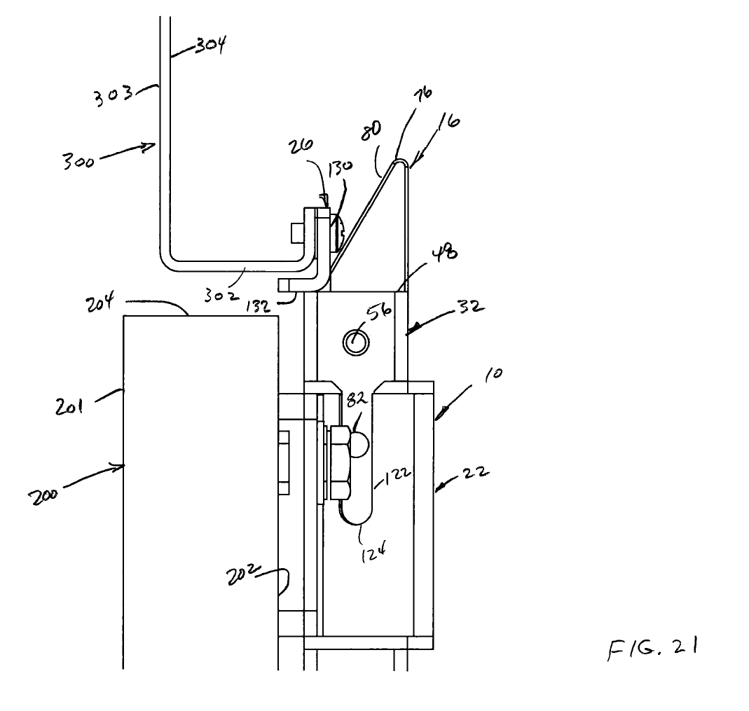

FIGS. 15-24 illustrate locking assembly 10 mounted to a portion of a door assembly 200 that is mounted to a portion of an enclosure 300. The door assembly 200 includes an outer surface 201, an inner surface 202, a first end 203, and a second end 204. The portion of the enclosure 300 includes a first opening edge 301, a second opening edge 302, an outer surface 303, an inner surface 304, and a floor member 305. FIGS. 15-19 illustrate the lock assembly in a retracted state with the first and second latches 14, 16 retracted relative to the first and second latch receivers 24, 26 with each of the latches 14, 16 in a fully retracted position. FIGS. 20-24 illustrate the lock assembly in an extended state with the first and second latches 14, 16 extended into contact with the first and second latch receivers 24, 25 with each of the latches 14, 16 in a fully extended position. The door assembly 20 may be locked relative to the enclosure portion 300 when the lock assembly is in the extended state.

The lock assembly 10 may have other states between the extended and retracted states in which either or both of the latches 14, 16 are in a position between the fully retracted and fully extended positions relative to the latch receivers 24, 26.

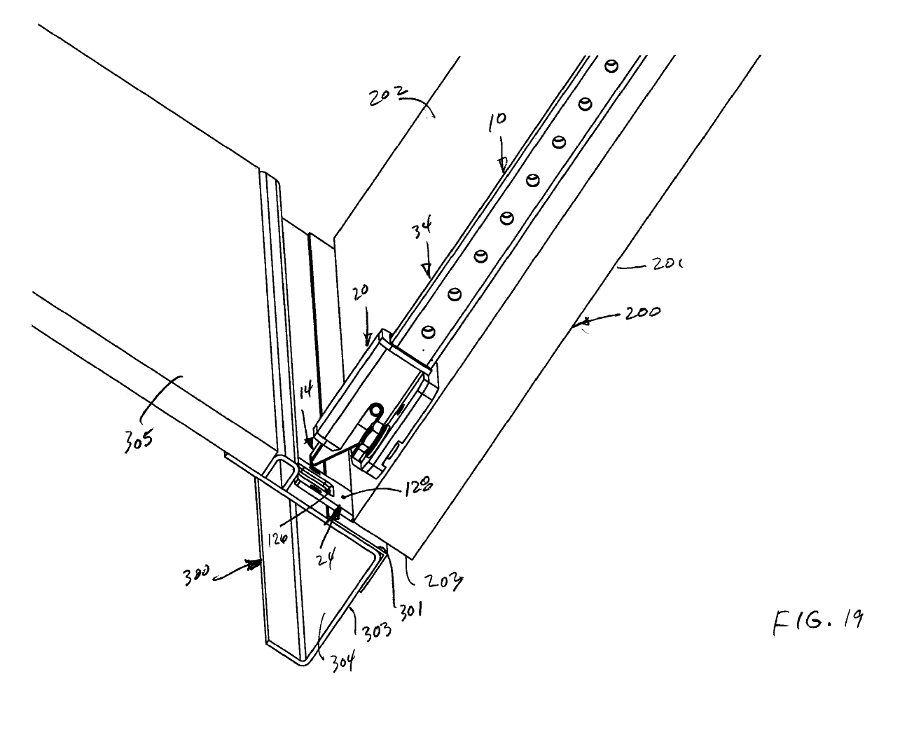

FIGS. 16 and 17 illustrate the second latch 16 in a retracted position in which the second latch connector 56 resides in the connector slot 122 of the second housing bracket assembly 22. FIGS. 18 and 19 illustrate the first latch 14 retracted relative to the first latch receiver 24. The first latch connector 66 is positioned within the connector slot 122 of the first housing bracket assembly.

FIGS. 21 and 22 illustrate the second latch 16 in an extended position in engagement with the second latch receiver 26. The first end 48 of the second housing 32 is in contact with the second housing contact surface 132 to resist further movement of the latch 16 in an extended direction relative to the second latch receiver 26. The second latch connector 56 is shown advanced out of the connector slot 122.

FIGS. 23 and 24 illustrates the first latch 14 in an extended position passed through the latch opening 126 of the first latch receiver 24. A first end 58 of the extension member 54 is in contact with the first housing contact surface 128 of the first latch receiver 24 to resist further movement of the first latch 14 in the extended or advanced direction relative to the first latch receiver 24.

A lock assembly 10 is shown in FIGS. 15-24 positioned on the inner surface 202 of the door assembly 200. More generally, the lock assembly 10 is shown positioned inward of the outer surface 201 of the door assembly 200. The lock assembly 10 is also shown positioned inward of an outer surface 304 of the enclosure portion 300. In this arrangement, no portion of the lock assembly 10 is accessible from the outer surfaces of the door assembly 200 and enclosure portion 300. There may be a number of advantages related to positioning of the lock assembly 10 at a location that is inaccessible from exterior of an enclosure.

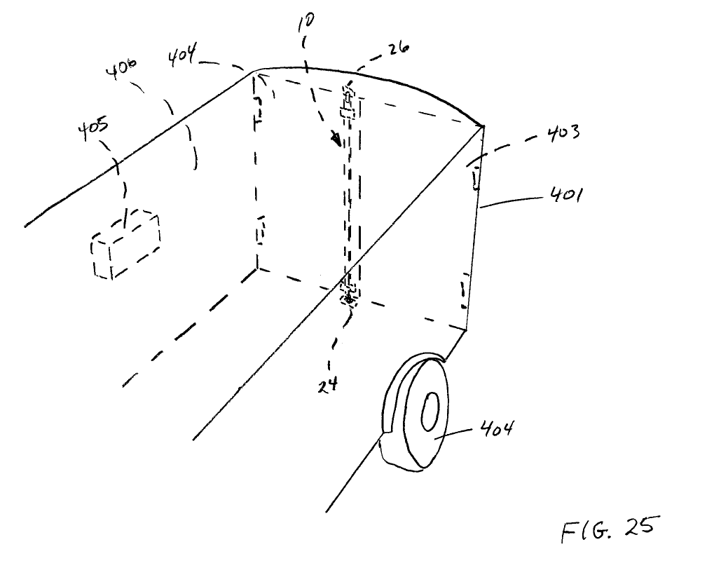

An example enclosure to which the lock assembly 10 may be mounted is the trailer 400 shown in FIG. 25. The trailer 400 includes a rear end 401, a first door 402, a second door 403, at least one wheel 404, a controller 405, and a trailer interior 406. The first and second doors 402, 403 are arranged mounted to the trailer 400 with hinge connections that provide pivoting of the doors 402, 403 about a generally vertical pivot axis. The lock assembly 10 is arranged on the first door of 402 inward (i.e., towards the interior 406) of an outer surface of the first door 402.

The lock assembly 10 is oriented generally vertically so as to extend from a top end to a bottom end of the first door 402. The first and second latch receivers 24, 26 are mounted on respective lower and upper edges of an opening into the trailer 400 that is covered by the first and second doors 402, 403 when in the closed position. The first door 402 may include an overlapping portion that contacts the second door 403 to maintain the second door 403 in the closed position when the first door 402 is also in the closed position. Thus, a single lock assembly 10 mounted to first door 402 may be able to maintain both the first and second doors 402, 403 in a closed position relative to the opening into the trailer 400 at the rear end 401.

Operation of the lock assembly 10 may be controlled via the controller 405. A user may access the controller 405 from a remote location using, for example, wireless communication with the controller 405. The controller 405 may have either wired or wireless communication capabilities relative to the lock assembly such as, for example, communications with the motor 84 to turn the motor 84 on and off and control the direction of rotational output of the motor 84. In one example, the user may activate the lock assembly by actuating a key fob, by inserting and turning a key at an exterior of the trailer 400, or pushing a button or flipping a switch that is located on an exterior of the trailer.

The controller 405 may provide other security measures related to the trailer 400. For example, the controller 405 may provide audible alarm signals, control lighting, and control locking or unlocking of wheels 404. Other details related to controller 405 are disclosed in, for example, U.S. Pat. No. 7,339,473, which is incorporated herein by reference in its entirety.

Various methods of operating the lock assembly 10 between retracted and extended positions and back to a retracted position are possible. In a first example, with reference to, for example, FIG. 2, the first and second latches 14, 16 are both in a retracted position relative to the first and second latch receivers 24, 26. The drive assembly 18 is activated to move one of the first or second latches 14, 16 into a fully extended position within a respective first or second latch receiver 24, 26. Subsequently, the other of the first and second latches 14, 16 is advanced to the fully extended position relative to its respective first or second latch receiver 24, 26. The lock assembly 10 operates automatically between advancing one of the latches to the fully extended position to begin advancing the other of the latches to the fully extended position. The lock assembly 10 may also be configured to automatically turn off the drive assembly upon both of the first and second latches achieving the fully extended position relative to the respective latch receivers 24, 26.

A method of retracting the first and second latches 14, 16 from fully extended positions relative to respective latch receivers 24, 26 as shown in FIG. 1 to the retracted position shown in FIG. 2 may follow the same principle of the above-described method of advancing the first and second latches 14, 16. This first retracting method may be initiated with activating the drive assembly 18 to begin retracting one of the first and second latches relative to its respective first or second latch receiver 24, 26 until the latch is moved to its fully retracted position relative to its respected latch receiver. Subsequently, the other of the first or second latch 14, 16 is retracted to its fully retracted position relative to its respective latch receiver 24, 26 until it obtains its fully retracted position. The lock assembly 10 may be configured to automatically switch between retracting one latch when it is fully retracted to begin retracting the other latch. Further, the lock assembly 10 may be configured to automatically turn off the drive assembly upon both of the first and second latches 14, 16 obtaining the fully retracted position relative to its respective latch receiver 24, 26.

Another example method of advancing the first and second latches 14, 16, from the retracted positions shown in FIG. 2 to the extended positions shown in FIG. 1 includes concurrent movement of the first and second latches 14, 16. In this method, the drive assembly 18 is activated to begin moving both of the first and second latches 14, 16 relative to its respective latch receiver 24, 26. The first and second latches 14, 16 move concurrently toward respective first and second latch receivers 24, 26 until both of the first and second latches 14, 16 achieve a fully extended position. The rate of movement of the first and second latches 14, 16 may be different, which may result in one of the latches achieving the fully extended position prior to the other latch reaching its fully extended position. The lock assembly 10 may be configured to automatically turn off the drive assembly 18 upon both the first and second latches 14, 16 achieving the fully extended position relative to respective first and second latch receivers 24, 26.

A second method of retracting the first and second latches from the extended position shown in FIG. 1 to the retracted position shown in FIG. 2 may follow the same principle of the above-described method that includes concurrent motion of the first and second latches 14, 16. According to this method of retraction, the drive assembly 18 is activated to begin moving the first and second latches relative to each other in a retracted direction. The first and second latches 14, 16 concurrently move from the extended position shown in FIG. 1 to the retracted position shown in FIG. 2 relative to respective first and second latch receivers 24, 26 until both of the 14, 16 achieve the fully retracted position. The rate of movement of the first and second latches 14, 16 may be different, which may result in one of the latches achieving the fully retracted position prior to the other. The lock assembly 10 may be configured to automatically turn off the drive assembly 18 upon both of the first and second latches 14, 16 achieving the fully retracted position relative to respective first and second latch receivers 24, 26.

A further example method of advancing first and second latches from the retracted position shown in FIG. 2 to the extended position shown in FIG. 1 includes advancing the first and second latches 14, 16 in a step-wise type movement sequence. The method may include activating the drive assembly 18 to begin advancing at least one of the first and second latches 14, 16 relative to its respective latch receiver 24, 26. One of the first and second latches 14, 16 begins advancing towards its respective latch receiver 24 a distance less than the fully extended position. Movement of that latch member stops and the other of the latch members begins to move towards its extended position. In some examples, the subsequent moving latch may move to an only partially extended position or may move to the fully extended position at which point movement of the subsequently moving latch ceases. The initially moving latch then moves again towards the extended position. This sequence of movement of one latch, followed by movement of the other latch occurs in series until both latches attain the fully extended position shown in FIG. 1. The lock assembly may be configured to automatically turn off the drive assembly upon both of the first and second latches 14, 16 achieving the fully extended position relative to the respective latch receivers 24, 26.

This method may include incremental steps of movement for each of the latch receivers that occurs in series (i.e., one latch moving followed by the other latch moving). Alternatively, during at least some portions of time both latches 14, 16 are moving toward the extended position. Thus, a combination of concurrent and stepwise, series movement of the first and second latches 14, 16 may occur while moving the latches 14, 16 toward fully extended position relative to respective latch receivers 24, 26.

There may be several factors related to the lock assembly 10 that may influence which of the first and second latches 14, 16 may advance towards the fully extended position at any given time. One such factor is resistance to movement of a latch member due to engagement with a surface of its respective latch receiver. Another factor may be friction that exists between the housing portion associated with the given latch and the housing bracket assembly 20, 22 through which the respective housing member passes while the drive assembly 18 is activated.

At least some of the above-described methods may be characterized as a “self-centering” operation for the lock assembly to advance the first and second latches 14 to fully extended positions relative to first and second latch receivers 24, 26. That is, there may be no predetermined sequence of movement of the first and second latches 14, 16. The immediate conditions of the lock assembly 10 and other influences such as, for example, characteristics of the substrate (i.e., door structure) and the enclosure to which the locking assembly is mounted may influence the sequence and timing in which each of the first and second latches 14, 16 advances toward the fully extended position.

A further method of retracting the first and second latches 14, 16 relative to respective latch receivers 24, 26 from a position shown in FIG. 1 to the position shown in FIG. 2 may substantially track the above described “self-centering” methods of advancing the latches. The lock assembly 10 may be configured to turn off the drive assembly upon both of the latches 14, 16 obtaining the fully retracted position relative to latch receivers 24, 26.

Automatic operation of the lock assembly to turn off or maintain on the drive assembly 18 may be determined in part upon variables such as time, power output, torque conditions, switch activations, and other characteristics of the lock assembly that can be measured and used to help determine operation of the drive assembly 10.

Referring now to FIGS. 26 and 27, several example door assemblies having various arrangements of lock assemblies are now described. Referring first to FIG. 26, an example door assembly 500 includes a door structure 599 having an inner surface 502, an opposing outer surface (covered from view by the inner surface 502), first and second ends 503, 504, and first and second opposing sides 505, 506. The door assembly 500 also includes a plurality of lock assemblies 510A-B positioned on the inner surface 502. The lock assemblies 510A, 510B are arranged to extend respective latch members 514A, 514B along respective ends 503, 504. The lock assemblies 510C, 510B include respective latch members 514C, 514D that extend along respective sides 505, 506. The latches 514A-D interface with respective latch receivers 524A-D that are mounted or otherwise supported on a substrate such as a portion of an enclosure to which the door assembly 500 is mounted.

The lock assemblies 10 are mounted to inner surface 502 with at least one bracket assembly 520A-D. The lock assemblies 510A, 510B are arranged substantially parallel with the first and second sides 505, 506. A direction of travel of the latches 514A, 515B between retracted and extended positions may be substantially parallel with the first and second sides 505, 506. The lock assemblies 510A, 510B and the direction of travel of the latches 514A, 514B may be arranged generally perpendicular to the first and second ends 503, 504.

The lock assemblies 510C, 510D may be arranged generally parallel with the first and second ends 503, 504. The direction of travel of the latches 514C, 514D may also be arranged generally parallel with the first and second ends 503, 504. The lock assemblies 510C, 510D and direction of travel of the latches 514C, 514D may be arranged generally perpendicular to the first and second sides 505, 506. In other arrangements, any one of the lock assemblies 510A-D may be arranged at a non-perpendicular angle relative to its respective end or side 503-506.

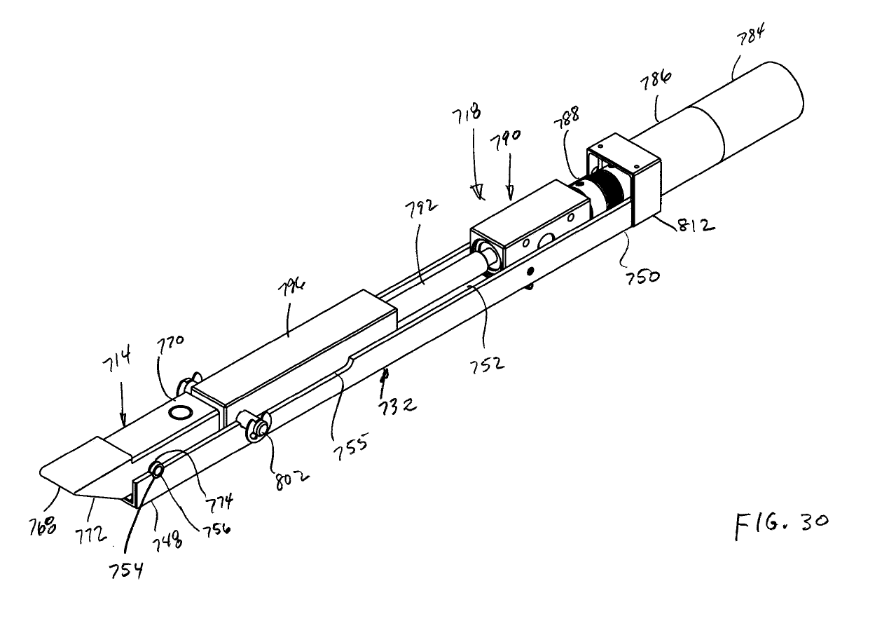

The example lock assemblies 510A-D are shown schematically only and represent one possible lock assembly configuration for use with the door assembly 500. Other lock assembly configurations are possible such as, for example, the use of a least one lock assembly including at least two latches such as the lock assembly 10 shown and described above with reference to FIGS. 1-25. Further, while four separate lock assemblies 510A-D are shown and described with reference to FIG. 26, other door assembly configurations may include combining any two or more of the lock assemblies 510A-D into a single lock assembly that includes two or more latch members. Further, while it is anticipated that each of the lock assemblies 510A-D includes its own separate motor for operating its respective latch 514A-D between extended and retracted positions relative to its latch receivers 524A-D, a single motor that operates more than one of the latches 514A-D may be used. Similarly, more than one motor may be used to operate any one of the latches 514A-D. Another example single latch lock assembly 710 is described below with reference to FIGS. 28-32. Any of the lock assemblies 510A-D may alone be considered a lock assembly portion having separable housing sections that define end portions of the lock assembly portion. Alternatively, any two or more of the lock assemblies 510A-D together may be considered a lock assembly portion having separable housing sections that define end portions of the lock assembly portion. For example, lock assemblies 510C and 510D could together be considered a lock assembly portion having separable housing section that define end portions of the lock assembly portion.

FIG. 26 includes multiple lock assemblies all positioned on the inner surface 502 of a door assembly 500. It may be possible to mount at least one lock assembly of a door assembly at a location inward from an outer surface of a door structure such as, for example at least partially positioned within a cavity defined in the door structure between the outer and inner surfaces of the door structure. FIG. 27 illustrates a door assembly 600 that includes a door structure 699 having an inner surface 602, an outer surface (not shown) that is positioned on an opposite side of the door structure 699 and spaced apart from the inner surface 602, and at least one cavity 612 defined between the inner and outer surfaces of the door structure 699. The cavity 612 may define at least one channel 613. The channel 613 and other portions of cavity 12 may be sized to house at least a portion of at least one of the lock assemblies 610A-D. At least one of the lock assemblies 610A-D may be disposed in the cavity 12. The lock assemblies 610A-D may each be a separate, individual lock assembly having at least one latch 614A-D (see also lock assembly 710 described below). In some arrangements, at least two of the lock assemblies 610A-D are combined into a single lock assembly or lock assembly portion such as, for example, the lock assembly 10 described above with reference to FIGS. 1-25.

The door assembly 600 may further include first and second ends 603, 604 and first and second sides 605, 606. The lock assemblies 610A-D may be associated with respective ends and sides 603-606. The latches 614A-D may be operable between retracted and extended positions to interface or engage with respective latch receivers 624A-D. The latch receivers 624A-D may be mounted to a substrate such as a portion of an enclosure in which the door assembly 600 is mounted.

The lock assemblies 610A-D may be completely enclosed within the door structure 699 of the door assembly 600 so as to be hidden from view except for the latches 614A-D that protrude from ends of sides of 603-606. Positioning at least one lock assembly at a location between the inner and outer surfaces of a door structure 699 may provide additional protection for the lock assemblies 610A-D to avoid damage to the lock assemblies during use of the door assembly 600. Enclosing at least portions of the lock assemblies 610A-D within the door structure 699 between inner and outer surfaces may also provide additional security that limits tampering with the lock assemblies 610A-D whether from an inside or outside location relative to the enclosure to which the door assembly 600 is mounted.

The lock assemblies 610A-D may be mounted to the door structure 699 of the door assembly 600 with at least one bracket assembly such as the bracket assemblies 20, 22 described above. The bracket assembly used to mount the lock assemblies 610A-D to the door assembly 600 may be positioned within the cavity 612. Alternatively, the lock assemblies 610A-D may be mounted using fasteners or the structures that extend through at least one of the inner surface 602 or outer surface of the door structure 699. In other arrangements, the structure of the cavity 612 and other features of the door structure 699 such as lips or wall structures along the ends and sides 603-605 retain the door assembly 610A-D in a predetermined position during operation of the lock assemblies to extend and retract the latches 614A-D relative to the latch receivers 624A-D.

Some of the example lock assemblies described herein extend across an entire width or along an entire height (or length) of a door structure to which the lock assembly is mounted (see width W and height H in FIG. 26). An example lock assembly 10 is shown mounted to a door 404 in FIG. 25 extending across an entire height between opposing upper and lower ends of the door structure 404. Latch members of the lock assembly 10 shown in FIG. 25 extend and retract relative to upper and lower opening edges of the enclosure that is covered by the door 404. FIG. 27 schematically illustrates the option of lock assemblies 610C-D being combined as a single assembly that extends across the entire width of the door structure 699, wherein the latches 614C, 614D interface with latch receivers 624C-D positioned on opposing first and second sides 605, 606 of the door structure 699.

FIGS. 26 and 27 illustrate other lock assembly arrangements in which an one of the lock assembly extends across only a partial length or width of the door structure. Lock assemblies having a length that extends across only a partial width or length of the door structure may have different advantages from lock assemblies that extend across an entire width of a door structure. Such advantages may relate to, for example, the type of door structure to which the lock assembly is mounted. Other advantages of latch assemblies that extend across a partial width of a door structure may include reduced manufacturing and materials costs, minimized effects on the structural integrity of the door due to smaller cavities that are required (in the case of an embedded lock assembly) and fewer mounting structures, and improved easy in concealing a smaller structure.

Various types of door structures may benefit from use with the example lock assemblies described herein. Some example door structures include swinging doors (i.e., the door structures 403, 404 shown in FIG. 25) that are mounted along a side edge of the door, ramp doors that are connected to the enclosure along a bottom edge of the door, up-swinging doors that are mounted to the enclosure along an upper end of the door, and roll-down doors that roll down from a raised position generally parallel with an upper surface of the enclosure to a closed position arranged generally perpendicular with the top surface and parallel with a side wall of the enclosure. These example door constructions may be positioned at various locations on an enclosure such as, for example, along a rear surface, front surface, side surface, top surface or bottom surface of an enclosure.

Many types of enclosures may benefit from the use of the example lock assemblies described herein and the door structures to which the lock assemblies are mounted. Some example enclosures include trailers (i.e., the trailers shown in FIG. 25), portable storage units (i.e., portable on demand storage (PODS®)), commercial containers, permanent storage units, moving vans or tracks, and various other enclosed or partially enclosed structures.

FIGS. 28-32 illustrate another example lock assembly 710. The lock assembly 710 includes a single latch 714 that extends and retracts into and out of engagement with a latch receiver 24. The lock assembly 710 may include a housing assembly 712 with the latch 714 mounted to a portion of the housing assembly 712. The lock assembly 710 may also include a drive assembly 718 and first and second housing bracket 720, 722.

The housing assembly 712 includes first and second housing 730, 732 that move relative to each other. The first housing 730 includes first and second ends 736, 738, and an interior 740. The second housing bracket assembly is positioned at the first end 736. The first housing bracket 720 is positioned at the second end 738. The second housing 732 is inserted into the interior 740 of the first housing 730 at the second end 738.

The second housing 732 includes first and second ends 748, 750, an interior 752, at least one latch connector aperture 754, a slot 755, and at least one second latch connector 756. The latch 714 is mounted to the first end 748. In at least one example, the latch 714 is inserted into the interior 752 at the first end 748. The second end 750 is inserted within the interior 748 of the first housing 730.

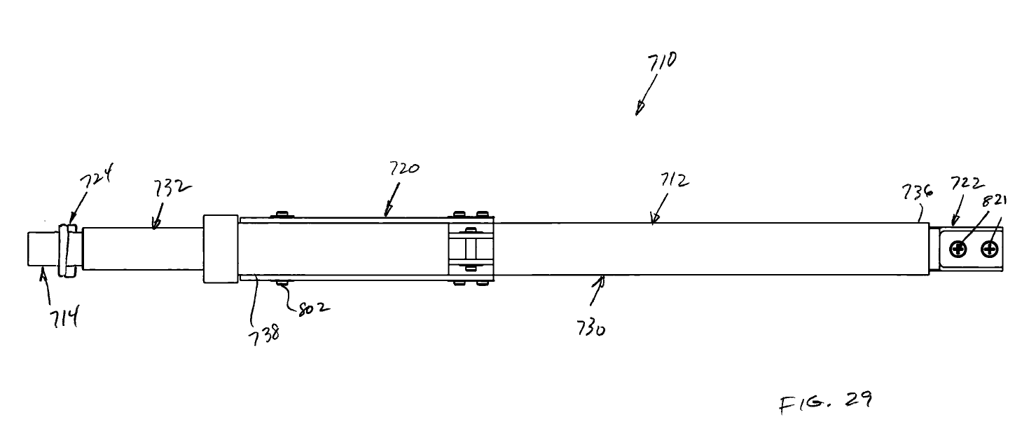

At least portions of the drive assembly 718 are positioned within the first housing 730. FIG. 30 illustrates portions of the drive assembly 718 positioned within the second housing 732. The drive assembly 718 may include a motor 784, a gear box 786, a motor coupling 788, a bearing assembly 790, a lead screw 792, a nut 794, and a nut mount 796. The bearing assembly 790 may include a plurality of bearing members 804. The lead screw 792 may include a plurality of external threads 106 along its length. The nut, also referred to herein as a lead screw guide, may include a threaded bore 808. Typically, the lead screw 792 is threadably engaged with the threaded bore 108 of the nut 96.

The nut 794 is mounted to the nut mount 796. The nut 794 is typically mounted to the nut mount 796 in a way that resists rotational movement of the nut 794 relative to nut mount 96 and the housing members 730, 732. The nut mount 796 may include a connector aperture 810 that receives a nut housing connector 802 that extends through the first housing 730 and first housing bracket 720 to provide a connection with the nut mount 796. The nut housing connector 802 may also be positioned within the slot 755 of the second housing 732.

In operation, rotation of the lead screw 92 by the motor 84 advances or retracts the nut 794 thereby advancing or retracting the nut mount 796 to move the first housing 730 relative to the second housing 32.

The second housing 732 is connected at its second end 750 to a coupling member 812. Coupling member 812 is positioned between the motor coupling 788 and the gear box 786, but may be positioned at other locations. The coupling member 812 fixes the second housing member 732 at its second end 750 to one end of the drive assembly 718. An opposing end of the drive assembly 718 (i.e., the nut mount 796) is connected to the first housing member 730 and is axially moveable relative to the first housing 732.

The latch 714 includes a distal end 768, a proximal end 770, a tapered surface 772, and an at least one connector aperture 774. The connector aperture 774 is positioned in alignment with the latch connector aperture 754 and sized to receive the second latch connector 756 to provide a connection between the second housing 732 and the latch 714. The proximal end 770 of the latch 714 may be inserted into the interior 752 of the second housing 732. In other arrangements, the latch 714 may be constructed to receive the first end 748 of the second housing 732 inserted into the proximal end 770 of the latch 714.

The tapered surface 772 may extend distally to the distal end 768. Tapered surface 772 may provide a reduced dimension portion of the latch 714 (i.e., reduced width or thickness) that promotes easier insertion of the latch 714 into the latch receiver 724. The tapered surface 772 may also define a contact surface arranged to contact portions of the latch receiver 724 as the latch 714 is extended to advance into, for example, an opening 826 finding the latch receiver 724 (see FIG. 28). The tapered surface 772 may extend along only a portion of a length of the latch 714.

The first housing bracket 720 includes structure for mounting the bracket 722 to a substrate such as, for example, a door structure. In at least one example, the first housing bracket 720 includes a plurality of connector protrusions 823 that penetrate a surface of the substrate to which the lock assembly 710 is mounted. The first housing bracket 720 may define an internal cavity through which the housing assembly 712 extends. A position of the first housing bracket 720 may be fixed relative to the first housing 730 by insertion of the nut housing connector 802 through the first housing 730 and into engagement with the nut mount 796.

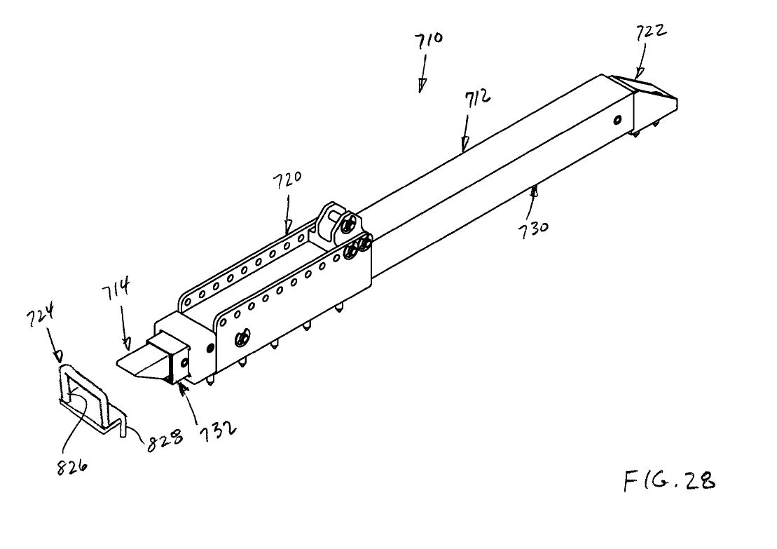

The second housing bracket 722 may include a plurality of connector apertures 822 sized to receive a plurality of bracket connectors 821 (see FIG. 29) and secure the second housing bracket 722 to a substrate such as, for example, a door structure.

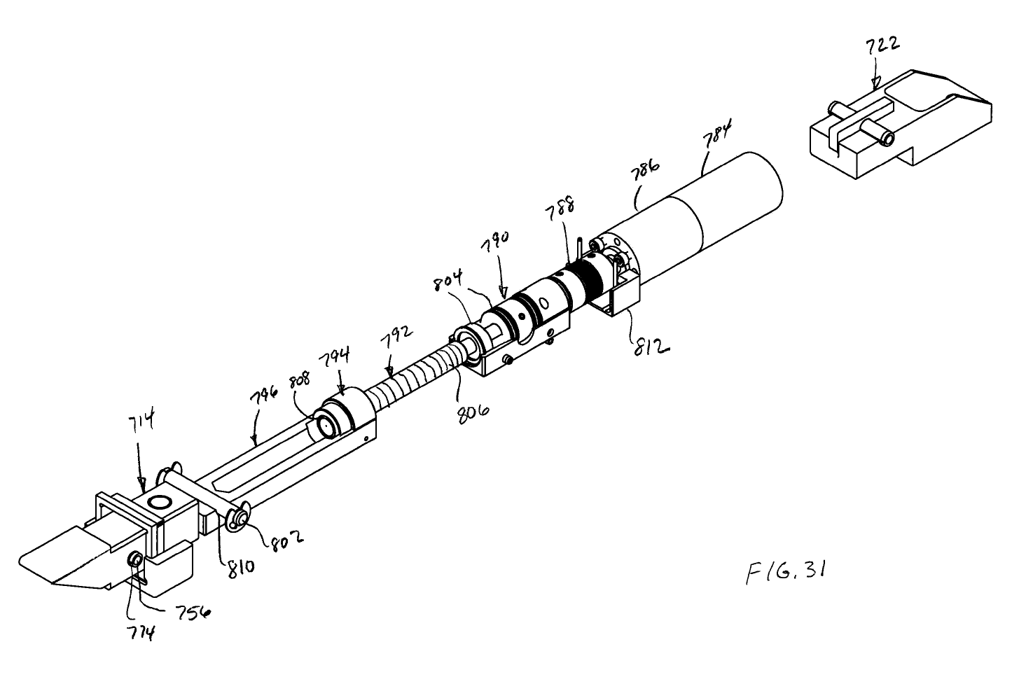

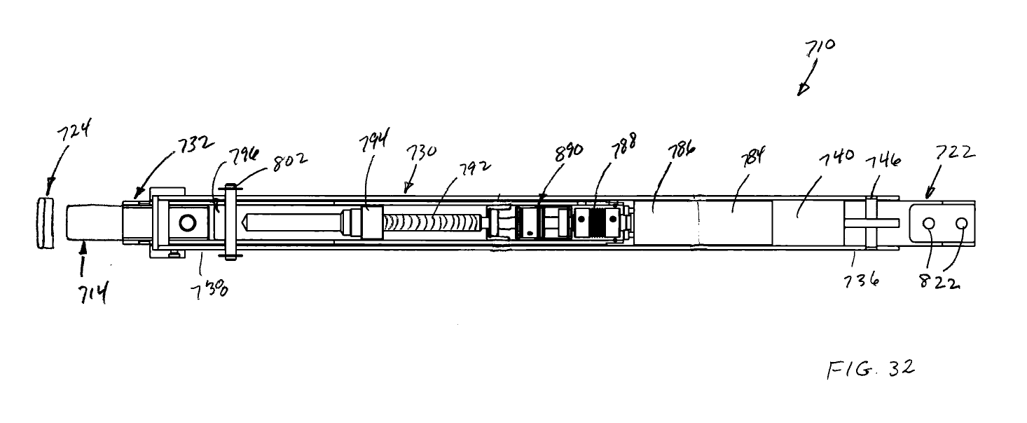

At least a portion of the second housing bracket 722 may be sized for insertion into the interior 740 of the first housing 732 at the first end 736. A housing bracket connector 746 may extend through the first housing 730 and the second bracket 722 to provide a connection therebetween (see FIG. 32). In other arrangements, the second bracket 722 and first housing 730 may be configured such that the first end 736 of the first housing 730 is inserted into a portion of the second housing bracket 722 to provide a connection therebetween.

The first latch receiver 724 may include a latch opening 826 and a housing contact surface 828. In operation, the drive assembly 718 is actuated to advance the latch 714 towards the latch receiver 724. The distal end 768 of the latch 714 extends through the latch opening 826 until the first end 748 of the second housing 732 contacts the housing contact surface 828. In at least some arrangements, the drive assembly 718 is configured to automatically turn off upon contact being made between the housing contact surface 828 and the second housing 732. In other arrangements, the drive assembly 718 is configured to automatically turn off after operating the motor 784 until another condition is met (i.e., lapse of a predetermined amount of time).

Many aspects of the lock assembly 710 are similar to the operation of the lock assembly 10. For example, the drive assemblies 18, 718 may have similar functions, components, and operations generally. The lock assembly 710 is different in some respects from the lock assembly in that one end of the housing assembly 712 is fixed relative to the substrate to which the lock assembly 710 is mounted. As described above, the lock assembly 10 includes a housing assembly 12 that is free floating relative to the substrate (i.e., the housing 12 moves axially relative to the first and second housing bracket assemblies 20, 22).

The lock assembly 710 may be operable with at least one of the first and second housing 730, 732 eliminated. In at least one example, the latch 714 can be mounted directly to a portion of the drive assembly 718 such as, for example, the nut mount 796. In other examples, portions of the drive assembly 718 may be directly mounted to the substrate (i.e., door structure) without the first housing 730 interposed there between. Many other variations related to the inclusion or exclusion of various components of the lock assembly 710 are possible while providing at least some of the same functionality and operation related to extending and retracting a latch relative to a latch receiver.

The lock assembly 710 may be operable with any of the example door structures and enclosures noted above referenced to lock assemblies 10, 510, and 610. The lock assemblies 710 may be mounted to a door structure at a location spaced inward from an outer surface of the door structure when the door structure is closed relative to an opening into an enclosure. In some examples, the lock assembly 710 is at least partially embedded with a door structure. In other examples, the lock assembly 710 is mounted to an inner surface of the door structure.

The lock assembly 710 may be controlled from a location exterior of the enclosure and at a location remote from the door structure to which the lock assembly 710 is mounted. The lock assembly 710 may be used in conjunction with a controller such as the controller 405 discussed above with reference to FIG. 25.

The lock assembly 710 may be interchanged with any of the lock assemblies 510A-D and 610A-D described above with reference to FIGS. 26 and 27. In at least some door assemblies, a plurality of lock assembly 710 can be positioned around peripheral edges of the door structure such as shown in FIGS. 26 and 27. In at least one example, two or more lock assemblies 710 are positioned along a single one of the ends or sides (i.e., ends and sides 503-506) of the door structure.

The lock assemblies described herein with reference to FIGS. 1-32 may be constructed as after market products that are added to an existing structure (e.g., added to a door of an enclosed trailer after purchase of the trailer). In some instances, the lock assemblies described herein with reference to FIGS. 1-32 may be integrated into a structure (e.g., a door structure that is mounted to a trailer) during manufacture of the structure as an original equipment manufactured (OEM) product.

Referring now to FIGS. 33-35, another example latch receiver 924 as shown and described. The latch receiver 924 is configured to receive a latch portion of a lock assembly such as one of the latches 14, 16 of the lock assembly 10 described above. The latch receiver 924 is typically mounted to an enclosure such as the trailer 400 described above with reference to FIG. 25. A latch member received by the latch receiver 924 is typically mounted to a door structure that at least partially covers an opening into the enclosure (i.e., door 403 shown in FIG. 25). The latch receiver 924 may include an adjustable latch retainer member 905. The latch retainer member 905 may provide the primary contact surface of the latch receiver 924 for the latch to engage. The latch receiver 905 may be moved to various locations on the latch receiver 924 to account for changes in a position of the latch. A position of the latch may change relative to the latch receiver 924 due to, for example, different mounted positions of the latch to a door structure, different door structure thicknesses, and different adjusted positions of the door structure relative to the enclosure.

The latch receiver 924 may include a base portion 901, first and second latch guides 902, 902 extending from the base portion 901, a support member 904 extending from the base portion 901, the latch retainer 905 mentioned above, and a support slot 917. The base portion 901 may include a plurality of mounting apertures 906, first and second ends 907, 908, first and second sides 909, 910, a rear surface 911, and a front surface 912. The mounting apertures 906 may be sized to receive a connector that extends through the base portion 901 to secure the latch receiver 924 through a portion of an enclosure. The first and second latch guides 902, 904 extend from the base portion 901 along the respective first and second sides 907, 908. The support member 904 extends from the first end 907. The latch retainer 905 is generally positioned at the second end 908. In at least some arrangements, the rear surface 909 faces and maintains contact with a surface of the enclosure. In other arrangements (as will be described in further detail below related to FIGS. 39-41) the latch receiver 924 is mounted to the enclosure using other features such as the support member 904 and support slot 917.

The first and second latch guides 902, 903 may include a plurality of retainer apertures 913. The latch retainer 905 extends from first latch guide 902 to the second latch guide 903 and is inserted into a retainer aperture 913 on at least one of the latch guides 902, 903. Adjusting a position of the latch retainer 905 can alter a distance D₁ from the front surface 912 of the base portion 901 to the latch retainer 905. As noted above, altering the distance D₁ help accommodate different positions of the latch of a lock assembly that is received by the latch receiver 924. The first and second latch guides 902, 903 can provide lateral (side-to-side) support of the latch when the latch is extended into the latch receiver 924.

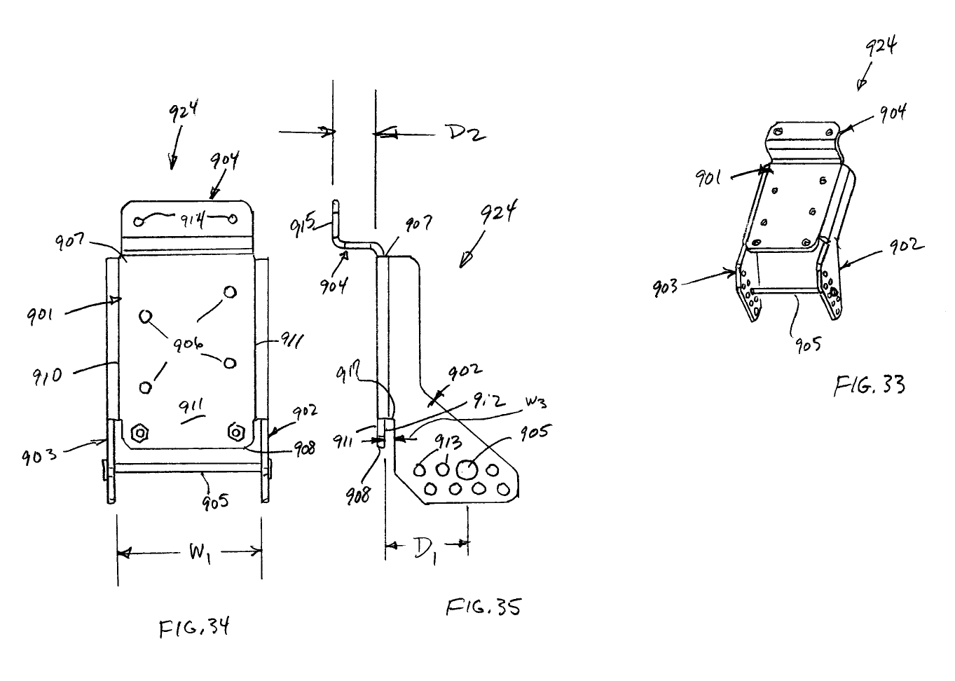

The support member 904 may include a plurality of connector apertures 914 and an adapter contact surface 915. The adapter contact surface 915 may be spaced apart from the rear surface 911 of the base portion 901 (see FIG. 35). The support member 904 may be arranged to provide support for the latch receiver 924 and a surface of the enclosure that is spaced apart from other mounting surfaces of the enclosure to which other portions of the latch receiver 924 are mounted. The support member 904 may also be configured to interface with an adapter bracket that is separately mounted to a portion of the enclosure as will be described in further detail below.

The latch retainer 905 is shown in the figures as a rod structure that extends through retainer apertures 913 of the first and second latch guides 902, 903. The latch retainer 905 may have any desired cross-sectional shape, size, shape along its length, and connection feature for mounting to the first and second latch guides 902, 903. In at least some arrangements, the latch retainer 905 is mounted to the first and second latch guides 902, 903 with a quick-release mechanism. In other arrangements, the latch retainer 905 is permanently mounted to the first and second latch guides 902, 903.

The support slot 917 is positioned along the second end 908. The support slot 917 is defined between a front surface with the base portion 901 and the first and second latch guides 902, 903. The supported slot 917 may have a width W₃ that is substantially the same as a thickness of a portion of the enclosure that is inserted into the support slot 917 (see description below related to FIG. 41).

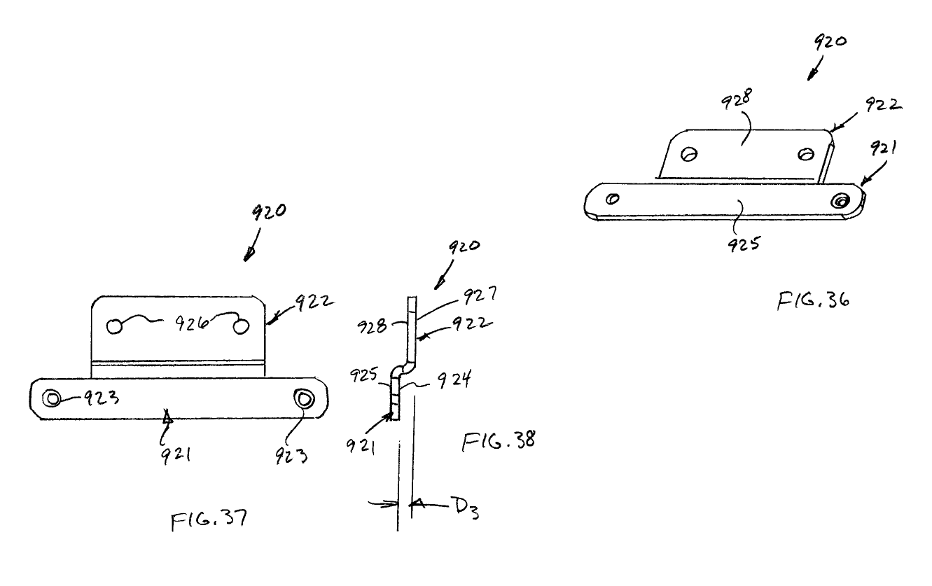

Referring now to FIGS. 36-38 and example adapter bracket 920 as shown and described. The adapter bracket 920 may be used in conjunction with the latch receiver 924 described above. The adapter bracket 920 may be mounted to the portion of an enclosure and to the latch receiver 924 to provide additional support for the latch receiver 924. The adapter bracket 920 may include a mounting portion 921 for mounting to the enclosure, and a receiver mounting portion 922 configured to interface with the latch receiver 924. The mounting portion 921 may include a plurality of mounting apertures 923, and first and second mounting surfaces 924, 925. Receiver mounting portion 922 may include a plurality of receiver apertures 926 and first and second receiver surfaces 927, 928. The mounting apertures 923 may be sized to receive a connector or fastener that extends therethrough for engagement with a portion of an enclosure. One of the mounting surfaces 924, 925 may contact a surface of the enclosure to which the adapter bracket is mounted. The receiver apertures 926 may be aligned with connecting apertures 914 of a support member 904 of the latch receiver 924. The aligned apertures 926, 914 may be configured to receive a connector or other attachment member to secure the latch receiver 924 to the adapter bracket 920. Either one of the first and second surfaces 927, 928 may be arranged facing the surface of the support member 904 of the latch receiver 924.

The receiver mounting portion 922 may be offset a distance D₃ from the mounting portion 921. The distance D₃ may be measured between the first mounting surface 924, the mounting portion 921 and the first receiver surface 927 of the receiver mounting portion 922.

Referring now to FIG. 39, an example mounting arrangement for the latch receiver 924 and adapter bracket 920 relative to an enclosure assembly 930 is shown and described. The enclosure assembly 930 includes first and second frame portions 932, 933. An opening having an opening perimeter 934 may be defined in the first frame portion 932. The first frame portion 932 includes a first mounting surface 935 and a top edge 936. The second frame portion 933 includes a mounting surface 937 and a top edge 938.

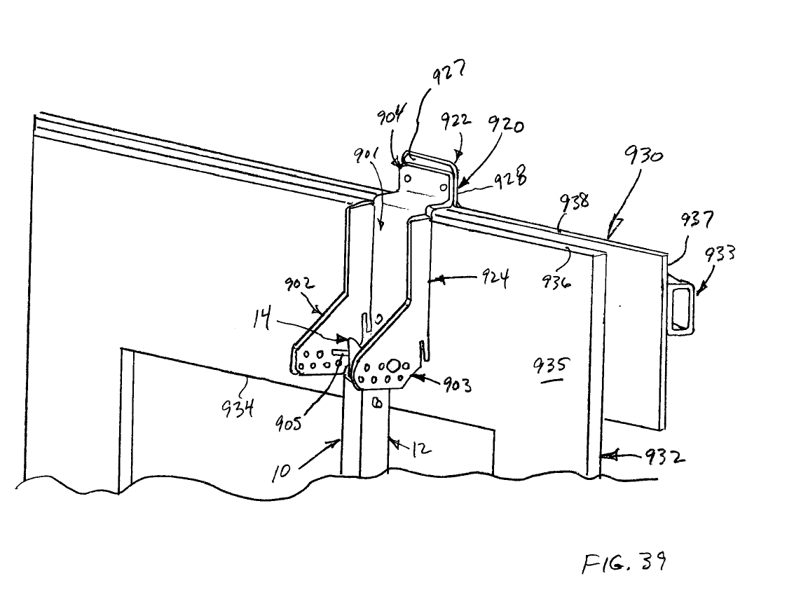

The latch receiver 924 is mounted to the first frame portion 932 with the rear surface 909 of the base portion 901 contacting the first mounting surface 935 of the first framed portion 932. The support member 904 extends over the top edge 936 of the first framed portion 932. The adapter bracket 920 is mounted to the second frame portion 933 with the mounting portion 921 mounted to the mounting surface 937 of the second frame portion 933. The receiver mounting portion 922 extends over the top edge 938 of the second frame portion 933 into a position adjacent to the support member 904 of the latch receiver 924. As the first and second frame portions 932, 933 are spaced apart from each other as shown in FIG. 39, the offset spacing D₂, D₃ shown in FIGS. 35 and 38 may be helpful to position the support member 904 adjacent to the receiver mounting portion 922. The distance of D₂, D₃ can be varied as needed to accommodate any particular spacing that exists between the first and second frame portions 932, 933.

The latch receiver 924 is positioned on the enclosure assembly in the area of the perimeter opening 934. A lock assembly 10 having a latch 14 extending from a housing assembly 12 may be operated to advance and retract the latch 14 into and out of contact with the latch retainer 905 of the latch receiver 924. In at least some arrangements, the lock assembly 10 shown in FIG. 39 is mounted to a door structure that at least partially covers the opening defined by the opening perimeter 934. The lock assembly 10, when in contact with the latch receiver 924, may hold the door structure in a closed position relative to the enclosure assembly 933.

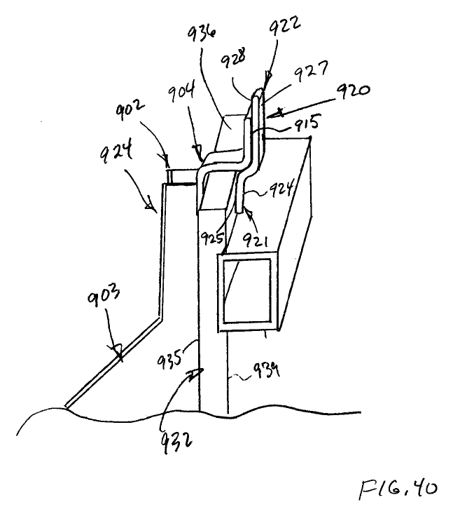

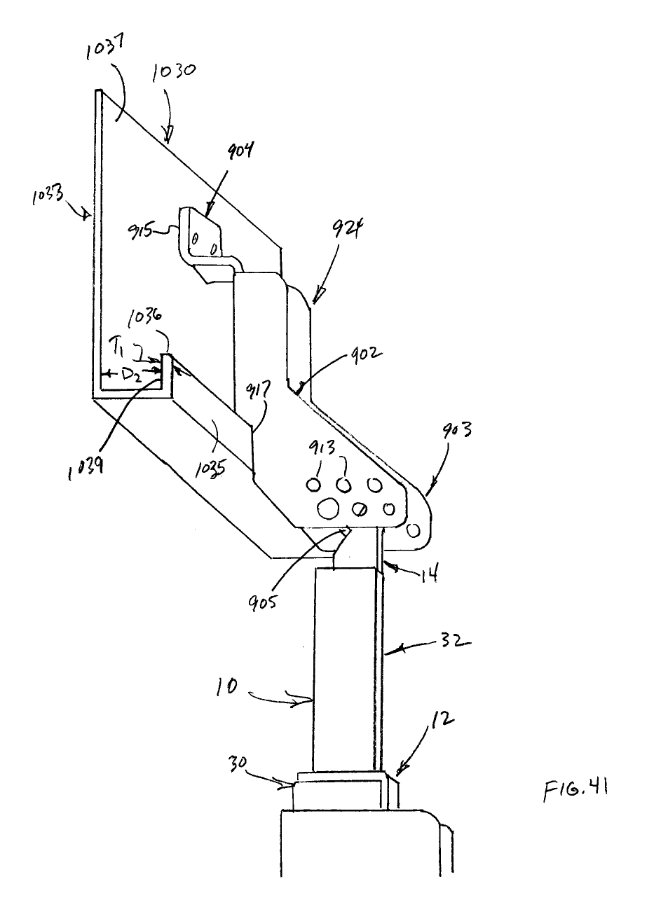

Referring now to FIG. 40, another example mounting arrangement for the latch receiver relative to an enclosure assembly 930 is shown and described. In FIG. 40, the enclosure assembly 930 includes only a first frame portion 932. The first frame portion 932 has first and second mounting surfaces 935, 939 and a top edge 936. The base portion 901 of the latch receiver 924 is supported against the first mounting surface 935. The support member 906 extends over the top edge 936. The adapter bracket 920 is arranged with the second mounting surface 925 contacting the second mounting surface 939 of the first frame portion 932. The second receiver surface 928 of the receiver mounting portion 922 extends above the top edge 936 of the first frame portion 932 and is arranged in contact with the adapter contact surface 915 of the support member 904. The adapter bracket 920 has been reversed in its orientation relative to the latch receiver 924 as compared to the arrangement of FIG. 39 so that the offset distance D₃ at least partially offsets the distance D₂ that the support member 904 extends from the base portion 901.

Referring now to FIG. 41, another example mounting arrangement for the latch receiver 924 is shown and described with reference to an enclosure assembly 1030. The enclosure assembly 1030 includes first and second frame portions 1032, 1033. The first frame portion 1032 includes opposed first and second mounting surfaces 1035, 1039, a top edge 1036, and a thickness T₁. The second framed portion 1033 includes a mounting surface 1037. The first and second frame portions 1032, 1033 may be connected to each other.

The first framed portion is inserted into the support slot 917 of the latch receiver 924. The opposed first and second mounting surfaces 1035, 1039 are supported within the support slot 917 to provide a first mounting support for the latch receiver 924. The support member 904 of the latch receiver 924 may extend into contact with the mounting surface 1037 of the second frame portion 1033. A spacing between the first and second frame portions 1032 and 1033 may have a distance of about the same as distance D₂ described above with reference to FIG. 35. The thickness T₁ of the first framed portion 1032 may be substantially the same as the width W₃ of the support slot 917.

The latch receiver 924 as shown in FIG. 41 may be mounted or otherwise supported on the enclosure assembly 1030 in at least two locations (i.e., the support slot 917 and support member 904). The latch receiver 924 is arranged to receive a latch 14 of a lock assembly 10, wherein the lock assembly 10 includes first and second housing members 30, 32 of a housing assembly 12, and the latch 14 engages the latch retainer 905 of the latch receiver 924.

While the invention has been particularly shown and described with reference to embodiments thereof, it will be understood by those skilled in the art that various other changes in the form and details may be made without departing from the spirit and scope of the invention.

We claim:

1. A lock assembly portion, comprising:
an elongate housing assembly having a first end portion and an opposite second end portion;
a first latch associated with the first end portion;
a second latch associated with the second end portion;
at least one latch drive; and
at least one actuator interfacing the latch drive to the first and second latches, wherein operation of the latch drive causes the first and second latches to move relative to one another between respective extended and retracted positions.

2. The lock assembly portion of claim 1 wherein the actuator includes a lead screw operatively coupled to the latch drive, and a lead screw guide receiving the lead screw.

3. The lock assembly portion of claim 1, wherein the housing assembly includes first and second separable housing sections which respectively define the first and second end portions.

4. The lock assembly portion of claim 3 wherein the first latch is associated the first housing section and the second latch is associated with the second housing section, there being a first actuator interfacing the first latch to a first latch drive, and a second actuator interfacing the second latch to a second latch drive.

5. The lock assembly portion of claim 2, wherein the lead screw guide comprises a nut, and wherein the lead screw threadably engages the nut.

6. The lock assembly portion of claim 5, wherein the nut is permitted to travel longitudinally within the housing assembly, but prohibited from rotating within the housing assembly.

7. The lock assembly portion of claim 2, wherein the lead screw guide is mounted to the housing assembly to permit longitudinal movement of the lead screw guide relative to the housing assembly and fix a rotational position of the lead screw guide relative to the housing assembly.

8. The lock assembly portion of claim 1, wherein the housing assembly includes an extension member for selectively varying an effective length thereof.

9. The lock assembly portion of claim 1, further comprising at least one housing bracket configured to mount the housing assembly to a support surface.

10. The lock assembly portion of claim 1, further comprising a first latch receiver, the first latch being movable into and out of engagement with the first latch receiver.

11. The lock assembly portion of claim 7, further comprising a second latch receiver, the second latch being movable into and out of engagement with the second latch receiver.

12. The lock assembly portion of claim 2, further comprising a gear box operatively coupled between the latch drive and the lead screw.

13. The lock assembly portion of claim 12, further comprising at least one bearing operatively coupled between the gear box and the lead screw.

14. The lock assembly portion of claim 1, wherein the first and second latches advance and retract along a common axis.

15. The lock assembly portion of claim 1, wherein the at least one latch drive and the at least one actuator are contained entirely within the elongate housing assembly.

16. A lock assembly comprising:
an elongate housing assembly having a first end portion and an opposite second end portion;
a first latch associated with the first end portion;
a first receiver sized to accommodate the first latch;
a second latch associated with the second end portion;
a second receiver sized to accommodate the second latch
a latch drive;
a lead screw operatively coupled between the latch drive and the latches; and
a lead screw guide coupled for relative movement with the lead screw, wherein operation of the latch drive advances the latches relative to one another between respective retracted positions, wherein the latches are disengaged from their associated receivers, to respective extended positions wherein the latches engage their associated receivers.

17. A storage container, comprising:
an enclosure having an interior;
at least one door providing access to the interior, the door having an inside surface facing into the interior, and an opposite outer surface;
a lock assembly for securing the door to the enclosure, the lock assembly comprising:
a first housing member disposed inwardly from the outer surface;
a second housing member disposed inwardly from the outer surface;
a first latch member associated with the first housing member;
a second latch member associated with the second housing member;
at least one latch actuator operably coupled to the first and second latch members;
a first latch receiver associated with the first latch member;
a second latch receiver associated with the second latch member, the first and second latch receivers being mounted to the enclosure;
wherein activation of the at least one latch actuator moves the first and second latches relative to one another between respective retracted positions, wherein the latches are disengaged from their associated receivers, to respective extended positions wherein the latches engage their associated receivers.

18. The storage container of claim 17, wherein at least a portion of a lock assembly is positioned at a location between the inside and outer surfaces of the at least one door.

19. A door assembly comprising:
a door comprising:
an inner surface;
an outer surface;
at least one cavity located between the inner and outer surfaces;
a portion of a lock assembly disposed in the cavity, the portion of a lock assembly comprising:
a first housing member having first and second ends;
a second housing member having first and second ends;
a first latch member associated with the first end of the first housing member;
a second latch member associated with the first end of the second housing member;
a latch actuator operably coupled between the first and second housing members;
wherein activation of the latch actuator moves the first and second housing members relative to each other to advance the first and second latch members out of the cavity in a plane parallel with the inner surface and retract the first and second latch members.

20. The door assembly of claim 19, wherein the door include a width and a height, and the portion of a door assembly spans one of the width or the height of the door.
